(19) United States
(12) Patent Application Publication
(10) Pub. No.: US 2024/0045065 A1
(43) Pub. Date: Feb. 8, 2024

(54) APPARATUSES AND METHODS FOR ASSESSING A LAWN SLOPE AT A LOCATION

(71) Applicant: Honda Motor Co., Ltd., Tokyo (JP)

(72) Inventor: Mark KISILER, Torrance, CA (US)

(21) Appl. No.: 17/882,855

(22) Filed: Aug. 8, 2022

(51) Int. Cl. G01S 17/89; G01S 17/86; B60R 11/04

(52) U.S. Cl. CPC G01S 17/89; G01S 17/86; B60R 11/04; B60R 2300/108; B60R 2011/005

(57) ABSTRACT

A system to assess a lawn slope to control water runoff and chemical concentrations at a location can include a tangibly embodied computer processor (CP) and a tangibly embodied database. The CP can implement instructions on a non-transitory computer medium disposed in the database. The database can be in communication with the CP. The system can include a grade measurement device including a device controller and a sensor. The CP can be configured to: receive grade profile data, map the grade profile data, compare the grade profile data an anchor point grade profile, calculate a grade score, determine whether to add or remove material to the grid area when the grade score for the grid area exceeds a predetermined grade threshold, and output a ground slope plan.

### BACKGROUND

The disclosed subject matter relates to apparatuses and methods for assessing a lawn slope at a location. More particularly, the disclosed subject matter relates to methods and apparatuses that can assess a lawn slope to control water runoff and chemical concentrations at a location.

Manual tools, manually operated machines, powered tools and powered machines can be used to create and maintain a landscape for a residential property or a commercial property. The manual tools and machines can be referred to collectively as manual equipment and include, but are not limited to, a rake, a shovel, a hoe, an aerator, pruning shears, a pruning saw, a tractor, and a lawnmower. The powered tools and powered machines can be driven by an internal combustion engine or an electric motor or a hybrid of an internal combustion engine and an electric motor. The powered tools and machines can be referred to collectively as powered equipment or power equipment and include, but are not limited to, a string trimmer, a hedge trimmer, a power saw, a lawnmower, a tiller, a snowblower, and a garden tractor.

Residential property owners, property managers and commercial property owners can manage the care of the lawn and other vegetation forming the landscape of the property on their own or through a professional landscape service or both. Do-it-yourself (“DIY”) lawncare can require the property owner/manager to invest in the purchase of any number of manual equipment and/or powered equipment. DIY lawncare can also require a substantial amount of time to perform the various tasks/duties required to achieve the desire aesthetics for the landscape of the property. Further, DIY lawncare can require the property owner/manager to preform repairs and preventative maintenance on the manual equipment and/or the powered equipment. The property owner/manager can perceive the repair and maintenance activates as an inconvenience or an undesirable obstacle for maintaining the desired aesthetics of the landscape.

As an alternative to DIY lawncare, a property owner/manager can employ the services of a professional landscaper to maintain the health and appearance of vegetation on the property at the desired level of aesthetics. A professional landscape service can have access to a wide variety of manual equipment and powered equipment that can permit the professional landscaper to execute the desire lawncare treatment more effectively and/or efficiently than the property owner/manager. However, the cost of the professional landscape services can outweigh the convenience to the property owner/manager.

### SUMMARY

Some embodiments are directed to a system to assess a lawn slope to control water runoff and chemical concentrations at a location, the system including a tangibly embodied computer processor (CP) and a tangibly embodied database, the CP implementing instructions on a non-transitory computer medium disposed in the database, and the database in communication with the CP, the system can include: a grade measurement device including a device controller and a sensor, the sensor configured to scan the lawn to create a lawn image, the device controller configured to process the lawn image into grade profile data; a communication portion for providing communication between the CP and the grade measurement device; the database that includes the non-transitory computer medium, and the database including the instructions, and the database storing a grid map that includes a plurality of grid areas that segregate the location; and the CP configured to: receive the grade profile data, map the grade profile data to each of the plurality of grid areas, compare the grade profile data of each of the plurality of grid areas to an anchor point grade profile, calculate a grade score for each of the plurality of grid areas based on the respective grade profile data relative to the anchor point grade profile, for each of the plurality of grid areas, determine whether to add or remove material to the grid area when the grade score for the grid area exceeds a predetermined grade threshold, select one or more tools from a plurality of tools, and output a ground slope plan that indicates where to add or remove the material on the location, wherein the ground slope plan includes reference to the one or more tools selected from the plurality of tools.

Some embodiments are directed to a lawncare apparatus, to assess a lawn slope to control water runoff and chemical concentrations at a location, the apparatus including a tangibly embodied computer processor (CP) and a tangibly embodied database, the CP implementing instructions on a non-transitory computer medium disposed in the database, and the database in communication with the CP, the apparatus comprising: a grade measurement device including at least two wheels rotatably connected to a frame, a device controller adjacent the frame, and a sensor adjacent the frame, the sensor configured to scan the lawn to create a lawn image, the device controller configured to process the lawn image into grade profile data; a communication portion for providing communication between the CP and the grade measurement device; the database that includes the non-transitory computer medium, and the database including the instructions, and the database storing a grid map that includes a plurality of grid areas that segregate the location; and the CP configured to: receive the grade profile data, map the grade profile data to each of the plurality of grid areas, determine a local maximum, a local minimum, and a plurality of corner anchor points for each of the plurality of grid areas based on the grade profile data, receive a location maximum anchor point and a location minimum anchor point, compare the local maximum, the local minimum, and the plurality of corner anchor points for each of the plurality of grid areas to the location maximum anchor point and the location minimum anchor point, calculate a grade score for each of the plurality of grid areas based on the local maximum, the local minimum, and the plurality of corner anchor points relative to the location maximum anchor point and the location minimum anchor point, for each of the plurality of grid areas, determine whether to add or remove material to the grid area when the grade score for the grid area exceeds a predetermined grade threshold, select one or more tools from a plurality of tools, and output a ground slope plan that indicates where to add or remove the material on the location, wherein the ground slope plan includes information related to the one or more tools selected from the plurality of tools.

Some embodiments are directed to a method to assess a lawn slope to control water runoff and chemical concentrations at a location, the method performed by a system including a tangibly embodied computer processor (CP) and a tangibly embodied database, the CP implementing instructions on a non-transitory computer medium disposed in the database, and the database in communication with the CP, the method can include: storing the instructions in the database; storing a grid map in the database, the grid map including a plurality of grid areas that segregate the location; scanning the lawn to create a lawn image; creating a grade profile data based on the lawn image; mapping the grade profile data to each of the plurality of grid areas; determining a local maximum, a local minimum, and a plurality of corner anchor points for each of the plurality of grid areas based on the grade profile data, receiving a location maximum anchor point and a location minimum anchor point, comparing the local maximum, the local minimum, and the plurality of corner anchor points to the location maximum anchor point and the location minimum anchor point for each of the plurality of grid areas, calculating a grade score for each of the plurality of grid areas based on the local maximum, the local minimum, and the plurality of corner anchor points relative to the location maximum anchor point and the location minimum anchor point, for each of the plurality of grid areas, determining whether to add or remove material to the grid area when the grade score for the grid area exceeds a predetermined grade threshold, outputting a ground slope plan that indicates where to add or remove the material on the location.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a schematic view of a prescriptive lawncare treatment system made in accordance with principles of the disclosed subject matter.

FIG. 2 is flowchart that outlines the general operation of the prescriptive lawncare treatment system of FIG. 1.

FIG. 3 is a schematic diagram showing details of the processing device 100 of FIG. 1, in accordance with principles of the disclosed subject matter.

FIG. 4 is a schematic diagram showing details of a grade assessment system (GAS) device 150 of FIG. 3.

FIG. 5 is a chart showing “GAS performs grade assessment processing” in accordance with principles of the disclosed subject matter.

FIG. 6 is a flowchart showing “GAS performs processing to set up grade assessment account for a user” of subroutine 310, in accordance with the principles of the disclosed subject matter.

FIG. 7 is a flowchart showing “GAS interfaces with user to edit/define boundaries for location” of subroutine 330, in accordance with the principles of the disclosed subject matter.

FIG. 8 is a flowchart showing “GAS interfaces with a user to input boundary information by interfacing with an online map” of subroutine 340, in accordance with the principles of the disclosed subject matter.

FIG. 9 is a flowchart showing “GAS interfaces with user to input boundary information using GAS device” of subroutine 350, in accordance with the principles of the disclosed subject matter.

FIG. 10 is a flowchart showing “GAS interfaces with user to generate grid map for location” of subroutine 370, in accordance with the principles of the disclosed subject matter.

FIG. 11 illustrates a location 400 that a user has set boundaries for to define the location boundary using defining points.

FIG. 12 illustrates the location 400 of FIG. 11 with a grid map 430 generated and overlayed thereon.

FIG. 13 illustrates a diagram of a grid area (GA) G8 from the grid map 430 of FIG. 12.

FIG. 14 is a flowchart showing “GAS performs assessment processing” of subroutine 500, in accordance with the principles of the disclosed subject matter.

FIG. 15 is a flowchart showing “GAS processes grade data and GPS data for current location” of subroutine 510 of FIG. 14, in accordance with the principles of the disclosed subject matter.

FIG. 16 is a flowchart showing “GAS maps observed data for grid area to recommendations (for user)” of subroutine 520 of FIG. 15, in accordance with the principles of the disclosed subject matter.

FIG. 17 is a flowchart showing “GAS processes lidar data (from the lidar sensor) to assess objects on location” of subroutine 530 of FIG. 14, in accordance with the principles of the disclosed subject matter.

FIG. 18 is a flowchart showing “server engages with user to generate lawncare prescription” of subroutine 750, in accordance with the principles of the disclosed subject matter.

FIG. 19 illustrates an embodiment of a user device having a graphical user interface (“GUI”), in accordance with the principles of the disclosed subject matter.

FIG. 20 illustrates a user performing grade assessment using the grade assessment system 140 of FIG. 4.

FIG. 21 is a schematic diagram of a topographic map.

FIG. 22 is a schematic diagram of a grade database.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

In addition to routine cutting, trimming, and pruning the vegetation that forms a property landscape, other maintenance of the landscape can include watering, chemical treatment, seeding, aeration and/or thatching, and leveling or grading the lawn. A property owner/manager can completely lack experience in basic lawncare or have very limited experience with lawncare. Further, a property owner/manager can completely lack or have only a basic understanding for diagnosing the health of the property's landscape and/or how to effect treatment of the landscape to improve or maintain the health of the landscape. Thus, there is a need for a prescriptive lawncare service that can help a property owner/manager to diagnose the current health of the property's landscape, maintain the health, modify the landscape to improve appearance and/or achieve the desired aesthetics, and perform the routine maintenance such as but not limited to grading the lawnscape.

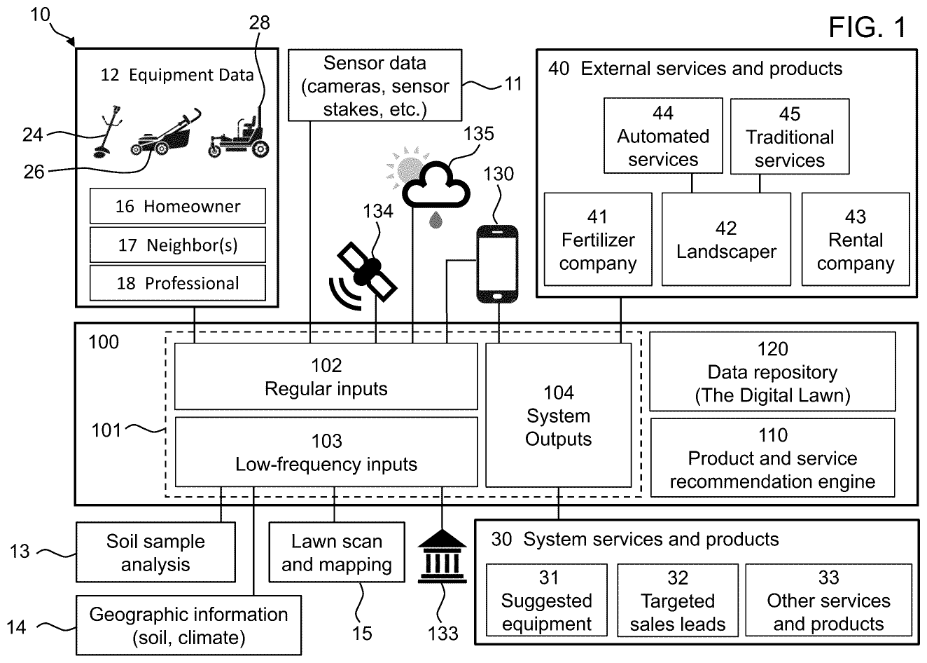

FIG. 1 is a schematic illustration of a prescriptive lawncare system (“PLC system”) 10 that can provide property owners/managers and professional landscapers with information about a relevant landscape, formulate a treatment plan for the landscape, recommend service(s) and equipment for executing the treatment plan, and/or provide instructions for executing the treatment plan. The PLC system 10 can include data processing device or system 100 (hereinafter “processing device 100”), sensor data 11, equipment data 12, soil sample analysis 13, geographic information 14, lawn scan and mapping data 15, system services and products 30, external services and products 40, a user interface 130, regulation and ordinance data 133, global positioning satellite (“GPS”) data 134, weather data 135.

The processing device 100 can include a communication portion 101, a processor-based controller 110, and a data storage device (also referred to as a data repository) 120.

The communication portion 101 can be electrically connected to a plurality of data inputs 11, 12, 13, 14, 15, 133, 134, 135, a plurality of equipment and/or service providers 30, 40, a user interface 130. FIG. 1 schematically illustrates a line connecting the communication portion 101 to each of the data inputs 11, 12, 13, 14, 15, 133, 134, 135, the providers 30, 40, the user interface 130. These lines can schematically represent a wired connection or a wireless connection. The electrical communication can be over a local computer network, or over the internet, or over a cellular network, or any combination these networks. The communication portion 101 can pass data and/or information between the controller and each of the data inputs 11, 12, 13, 14, 15, 133, 134, 135, the providers 30, 40, the user interface 130.

The communication portion 101 can include a plurality of regular inputs 102, a plurality of low-frequency inputs 103 and a plurality of system outputs 104. The regular inputs can be in electrical communication with sensor data 11, equipment data 12, a user interface 130, GPS data 134, weather data 134.

The sensor data 11 can include data indicative of the color and density of the lawn, the moisture content, sunlight exposure, etc. The sensor data 11 can be obtained by any appropriate device(s) such as but not limited to a camera, sensor stakes, etc.

The equipment data 12 include the type of lawncare equipment 16 that is owned by the property owner/manager, the type lawncare equipment 17 owned one or more neighbors, the type of lawncare equipment 18 being used on the property by a professional landscape service. The equipment data can include data indicative of handheld tools 24, walk-behind machines 26, and ride-on machines 28 and whether the equipment is manually operated, powered by an internal combustion engine, powered by an electric motor, or powered by a hybrid of an internal combustion engine and electric motor. The equipment data can 12 include data indicative of the hours of operation, the maintenance schedule, completed maintenance, etc., for each piece of equipment.

The user interface 130 can be any appropriate electronic device, such as, but not limited to, a cellular (mobile) telephone, a tablet computer, a laptop computer, a desktop computer, a server terminal, that can permit a user to input requests for information to and receive information generated by the processing device 100.

The GPS data 134 can include satellite image(s) of the property and neighboring properties, street level image(s) of the property and neighboring properties, map data of the property and neighboring properties, and address information of the property and neighboring properties. Any number of user interfaces 130 can be in electrical communication with the processing device 100.

The weather data 135 can include data indicative of temperature (daily highs and lows, averages, maximums, minimums, current) precipitation amounts, amount of sunshine (average, maximums, minimums, current). The weather data 135 can be obtained from a service provider or government agency.

The low-frequency inputs 103 can be electrically connected to data sources such as, but not limited to, a soil sample analysis 13, geographic information 14, lawn scan and mapping data 15, and regulation/ordinance information 133. The data representing the soil sample analysis 15 can be provided by a third party or determined by the controller 110 using data output by a soil analysis apparatus in electrical communication with the controller 110, where the output data is based on a soil sample introduced to the analysis apparatus by the user. The lawn scan and mapping data 15 can be based on data obtained from, but not limited to, a formal land survey, satellite imagery, a digital image scan of the landscape, and government agency(ies) such as the U.S. Geological Survey and U.S. Department of Agriculture. The regulation/ordinance information 133 can be obtained from any appropriate local, regional or national government agency or from a subscription database of local, regional and national regulations and ordinances.

The system outputs 104 can be in electrical communication with the user interface 130 and the service and/or equipment providers 30, 40. The system outputs 104 can output a treatment plan and/or other information requested by the user and can output requests or notifications to the service and/or equipment providers 30, 40 based on the treatment plan and/or other information requested by the user.

The processor-based controller (“controller”) 110 can be an electronic computing device such as but limited to an electronic control unit (“ECU”), a central processing unit (“CPU”), a microcontroller, a microcomputer, a server, a plurality of electronic computing devices or servers, or other appropriate processor-based controller(s) that can receive data inputs, execute commands for processing the data inputs, and output a treatment plan based on the executed commands. The controller 110 can be configured with hardware alone or in combination with software to execute commands that process the data inputs and output any of a plurality of lawncare treatment plans in accordance with the disclosed subject matter. The controller 110 can be referred to as a product and service recommendation engine.

For example, the controller 110 can be configured to interact with the user interface 130 and permit the user to request a fertilizer plan for the landscape. The controller 110 can be configured to determine a fertilizer content and schedule based on data input by the user and data input from any appropriate one(s) of the data inputs 11, 12, 13, 14, 15, 133, 134, 135. In another example, the controller 110 can be configured to permit the user to request a sunlight evaluation of the landscape based on measured sunlight data input to the controller 110 and recommend a treatment plan for the landscape based on the processed sunlight data. In yet another example, the controller 110 can be configured to permit the user to request an evaluation of the grade of the lawn and output a recommended an adjustment of the grade and provide the user with instructions and recommendations on how to achieve the recommended grade. In yet another example, the controller 110 can be configured to permit the user to request a soil analysis of the landscape, recommend a treatment plan for the landscape soil, and provide a water run-off analysis after the user implements the treatment plan. In yet another example, the controller 110 can be configured to permit the user to select a desired aesthetic appearance of the landscape, recommend a treatment plan that can achieve the desired aesthetic appearance, and rank the recommended treatment plan according to predetermined parameters such as but not limited to difficulty, cost, equipment availability. The controller 110 can be in electrical communication with the inputs 102, 103, the outputs 104 and the data storage device 120.

The data storage device 120 can be any appropriate non-transitory recording or storage medium such as, but not limited to, a CD-ROM, a DVD-ROM, a hard drive, a RAM, a ROM, a floppy disc, and a magnetic tape cassette, or later developed medium such as, but not limited to, transitory recording medium, or carrier waves. The data storage device 120 can include the some or all of the software that is executed by the controller 110 in order to provide the treatment plan(s) requested by the user. The data storage device 120 can store data created by the controller 110 that is indicative of the one or more parameters of the landscape such as, but not limited to, grade, type(s) and location(s) of the vegetation, water-run-off analysis, scanned images, map information, soil analysis, coloration of the vegetation, chemical analysis of the vegetation. These parameters can be referred to as the digital lawn.

The provider of the PLC system 10 can be a manufacturer of lawncare equipment. The system services and products 30 can include lawncare products manufactured by the manufacturer, other service(s) on offer by the manufacture and other products available from the manufacturer. The processing device 100 can communicate with the system services and products 30 to provide the user with suggested equipment 31, sales information 32, other services/products 33. The sales information can include the location of a lessor, retailer or dealer of the suggested equipment. The controller 110 can be configured to send a message to the lessor, retailer or dealer indicative of the user's desire of or inquiry regarding the suggested equipment so that the lessor, retailer or dealer can initiate contact with the user about a possible sale or lease of the suggested lawncare equipment.

The manufacturer of lawncare equipment and provider of the PLC system 10 can also offer other services such as, but not limited to, professional landscaping, professional lawncare maintenance, and other products such as, but not limited to, portable generators, cars, pick-ups, sports-utility vehicle, cross-over vehicle, vans, motorcycles, all-terrain vehicle, outboard motors, and aircraft. The controller 110 can be configured to provide the user with information regarding any of the other products on offer from the manufacture.

The external services and products 40 can be any third party entity not affiliated with the provider of the PLC system 10 such as, but not limited to, a manufacturer 41 of fertilizer, a professional landscaper 42, or a rental company 43 that leases lawncare equipment. The controller 110 can be configured to provide the user and any of component of the external services and products 40 with information about each other. For example, the controller 110 can be configured to output a message to a professional landscaper that indicates that the user is interested in hiring a professional landscaper. The controller 110 can be configured to obtain information from the landscaper 42 such as cost, services provided and equipment used and provided this information to the user via the user interface 130. For example, the landscaper can have traditional lawncare equipment 45 that is operated by a designated person, or automated lawncare equipment 44 that is operated remotely or fully autonomous.

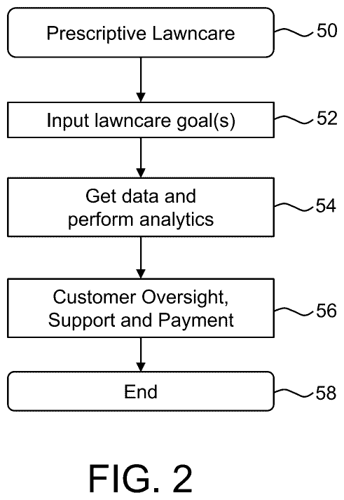

FIG. 2 is flowchart illustrating the general operation of the controller 110. At step 50, the user can initiate a prescriptive lawncare service session with a user via the user interface 130. The controller 110 can then move to step 52.

At step 52, the controller 110 can be configured to prompt the user to input one or more lawncare goals for the property. The controller 110 can be configured to move to step 54 when the user has entered all of the goals to the controller 110.

At step 54, the controller 110 can be configured to access all of the data inputs data inputs 11, 12, 13, 14, 15, 133, 134, 135, that are appropriate to generate a treatment plan in accordance with the user's goal(s). After obtaining the data, the controller 110 can be configured to analyze the obtained data in accordance with predetermined computations and comparisons. After completing the analysis, the controller 110 can move to step 56.

At step 56, the controller 110 can be configured to generate and output a treatment plan based on the analysis performed at step 54. The controller 110 can be configured to prompt the user to request or decline supplemental information regarding the treatment plan. The supplemental information can include information from the system services and products 30, information from the external services and products 40, instructions on how to execute the treatment plan, frequently asked questions (“FAQs”) related to the treatment plan, etc. At step 56, the controller 110 can be configured to accept payment from the user for the treatment plan and for any services and products ordered for the execution of the treatment plan.

After completing the payment(s), the controller 110 can be configured to end the prescriptive lawncare service session.

As an example of the execution of the flowchart of FIG. 2, the user can select a set a specific goal of the lawn at step 52 that indicates a lush, thick grass lawn. The controller 110 can execute one or more subroutines at step 54 that are predetermined for use in generating a treatment plan directed toward a lush, thick lawn. The subroutine(s) executed at step 54 can include steps to obtain data regarding the type of grass on the property, historical rainfall and temperature data for the property, grade of the lawn on property, historical sunlight data from the property, and soil analysis data for the property, and ordinances and regulations regarding chemical treatments to land in the jurisdiction of the property. The controller 110 can output a treatment plan at step 56 that includes the application of fertilizer and a list of chemical(s) that are permitted by ordinance/regulation for the property. and retailers of the permitted chemical(s). The controller 110 can be configured to prompt for and accept payment for the treatment plan and any chemical(s) order using the PLC system 10.

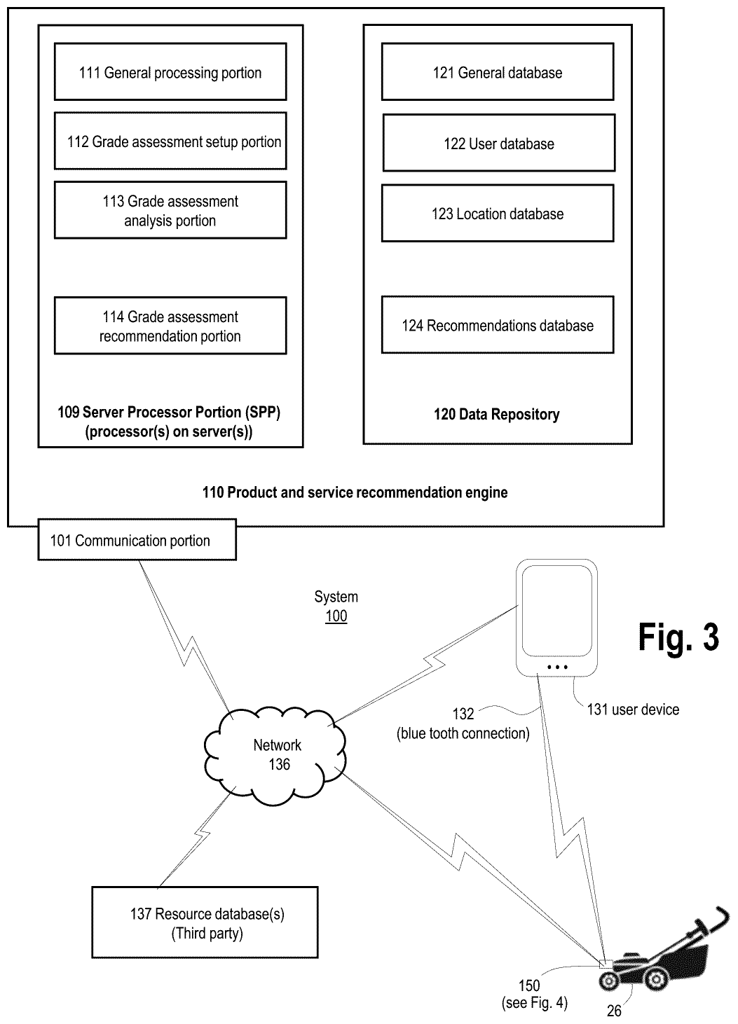

FIG. 3 is a schematic diagram showing details of the processing device 100, in accordance with principles of the disclosed subject matter. The processing device 100 can include the controller 110. The controller 110 can include a server processor portion (SPP) 109 and the data storage device 120. The SPP 109 can perform various processing to provide the features and functionality as described herein. The SPP 109 can include a general processing portion 111. The general processing portion 111 can provide various general processing of the controller 110 including data maintenance, security related processing, and other general processing not handled by specialized processing portions of the controller 110.

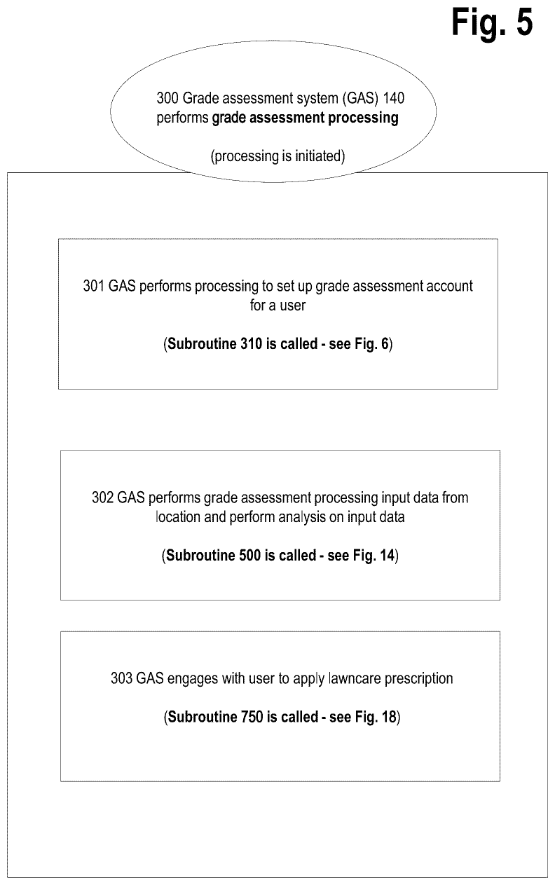

The SPP 109 can also include a grade assessment setup portion 112, a grade assessment analysis portion 113, and a grade assessment recommendation portion 114. The grade assessment setup portion 112 can perform various processing related to the setup of a grade assessment. Such processing can include the processing illustrated in FIGS. 5-7, for example. The grade assessment analysis portion 113 can perform various processing related to the analysis of a grade assessment. Such application might include a user or lawn technician scanning a lawn at a home or other location, for example, to provide data that can be processed into a topographical map displaying areas that may be candidates for grade adjustment. The grade assessment recommendation portion 114 can perform various processing related to the recommendation of a lawncare prescription (also referred to as a ground slope plan) based on the grade assessment. Such application might include recommendation of tools, material, locations, and/or services for the lawncare prescription. Such processing can include the processing illustrated in FIGS. 5, 18, and 19, for example. The processing portions of the SPP 109 can provide various functionality, as described herein, based on instructions or code in the data storage device 120.

The data storage device 120 can include various database portions. The data storage device 120 can include a general database 121, a user database 122, a location database 123, and a recommendations database 124.

The general database 121 can store various data used by and/or generated by the general processing portion 111. The user database 122 can include various information regarding users of the controller 110. For example, the user database 122 can include credentials that allow a user to access the controller 110. The user database 122 might also include historical data of a user. Such historical data might include all the lawncare prescriptions that a particular user has created using the controller 110. Accordingly, if a user assessed that a particular lawncare prescription worked well in a past job, the user might “bring up” such lawncare prescription for application in a current job.

The data storage device 120 can also include the location database 123. The location database 123 can include various information regarding locations serviced by the controller 110, prescriptions that were used or applied at locations, and other related data.

The data storage device 120 can also include the recommendations database 124. The recommendations database 124 can include various data that relates to recommendations for lawncare prescriptions. Accordingly, the recommendations database 124 can include data that represents tools, materials, supply stores, service providers, and rental equipment. The recommendations database 124 can also include data of nearby rental and/or seller facilities including but not limited to proximity, hours of operation, costs, advertising and/or promotional data. For example, the recommendations database 124 may include the price and customer review of a lawncare prescription for a neighboring lawn that was carried out by a service provider located within 5 miles of a user's location.

The controller 110 can also include the communication portion 101. The communication portion 101 can provide communication between the controller 110 and external entities or components. Communication can be performed over a network 136. For example, the communication portion 101 can communicate with a resource database(s) 137 over the network 136. The resource database 137 can provide, to the controller 110, the various resources, such as applicable topographic data, for example from the United States Geological Survey's (USGS) database, that are used by the controller 110. The resource database 137 can be in the form of one or more databases. The resource database 137 can be in the form of many databases spread out over, and relating to, different states, towns, cities, localities, and geographical regions, for example.

Also, the resource database 137 can include various data relating to different products that the controller 110 services. For example, the controller 110 can retrieve first product data from a database of a first company, which makes a first product. The controller 110 can retrieve second product data from a database of a second company, which makes a second product. The resource databases 137 can include a wide variety of databases that relate to products and services, for example.

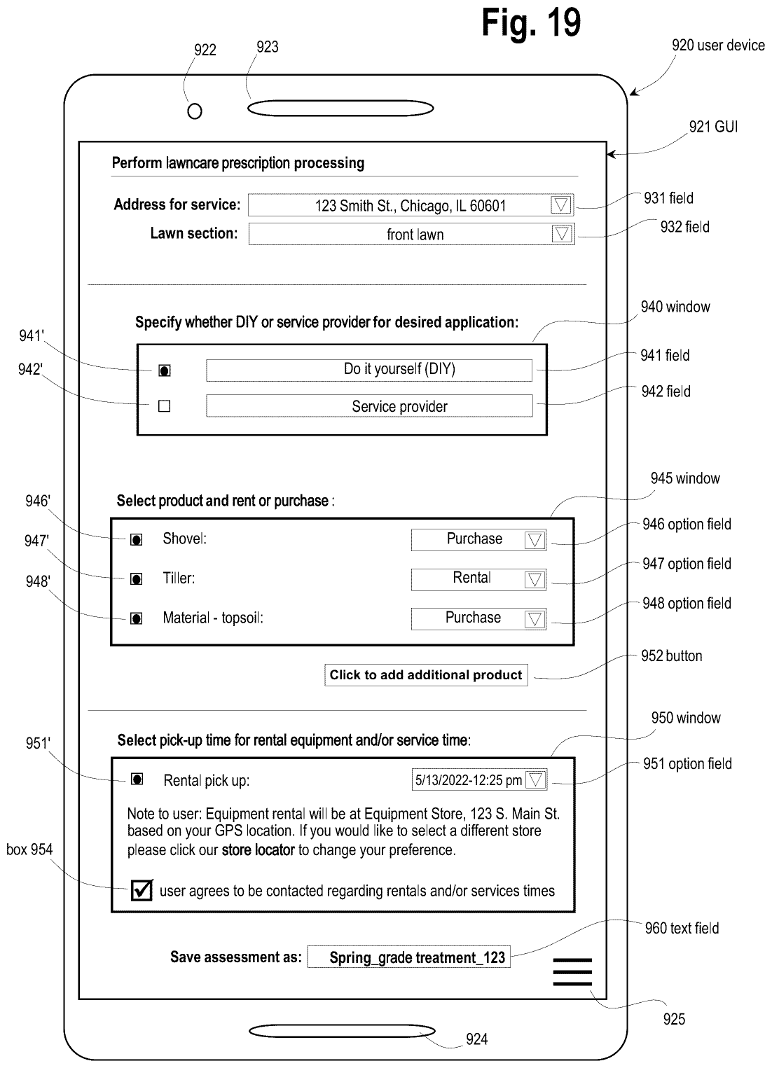

As shown in FIG. 3, the processing device 100 can also include an illustrative first user device 131, a grade assessment system (GAS) device 150 (also referred to as a grade measurement device), and the walk-behind machine 26. The first user device 131 and the network 136 can communicate wirelessly with the GAS device 150 mounted to the walk-behind machine 26. The communication between the first user device 131 and the GAS device 150 can be through blue tooth connection 132, for example. Illustratively, the first user device 131 can be described as a user that creates a lawncare prescription, such as by using the graphical user interface (“GUI”) of FIG. 19. For example, such user might utilize the GUI of FIG. 19.

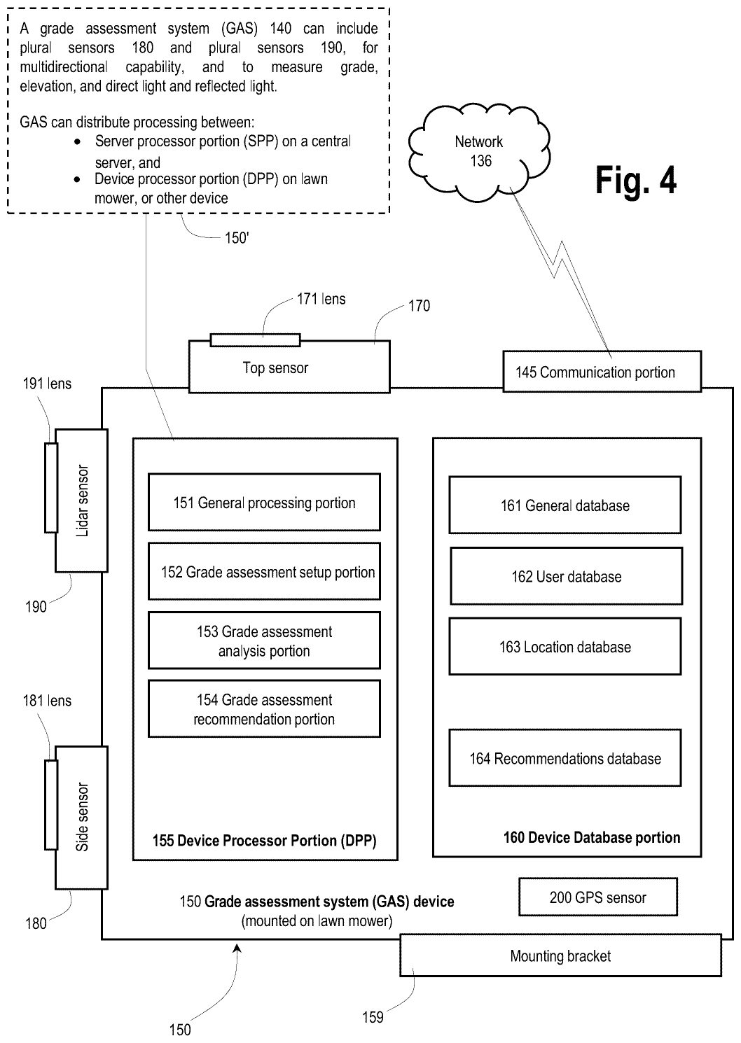

FIG. 4 is a schematic diagram showing details of a GAS device 150, in accordance with principles of the disclosed subject matter. The GAS device 150 can include a device processor portion (DPP) 155, a device database portion 160, a communication portion 145, a mounting bracket 159, and a sensor array including a top sensor 170 having a lens 171, a side sensor 180 having a lens 181, a lidar sensor 190 having a lens 191, and a GPS sensor 200. The communication portion 145 can be in wireless communication with the network 136. The GAS device 150 can compile elevation data and GPS data. The GAS device 150 can be part of a grade assessment system (GAS) 140 that can be an implementation of the system 100. The GAS device 150 can be attached to a walk-behind machine 26, for example. Alternatively, the GAS device 150 can be a standalone machine that includes at least two rotatably connected wheels connected to a frame, a device controller, and a sensor mounted to the frame. The GAS device 150 can also include a material storage and can distribute material from the material storage based on the lawncare prescription.

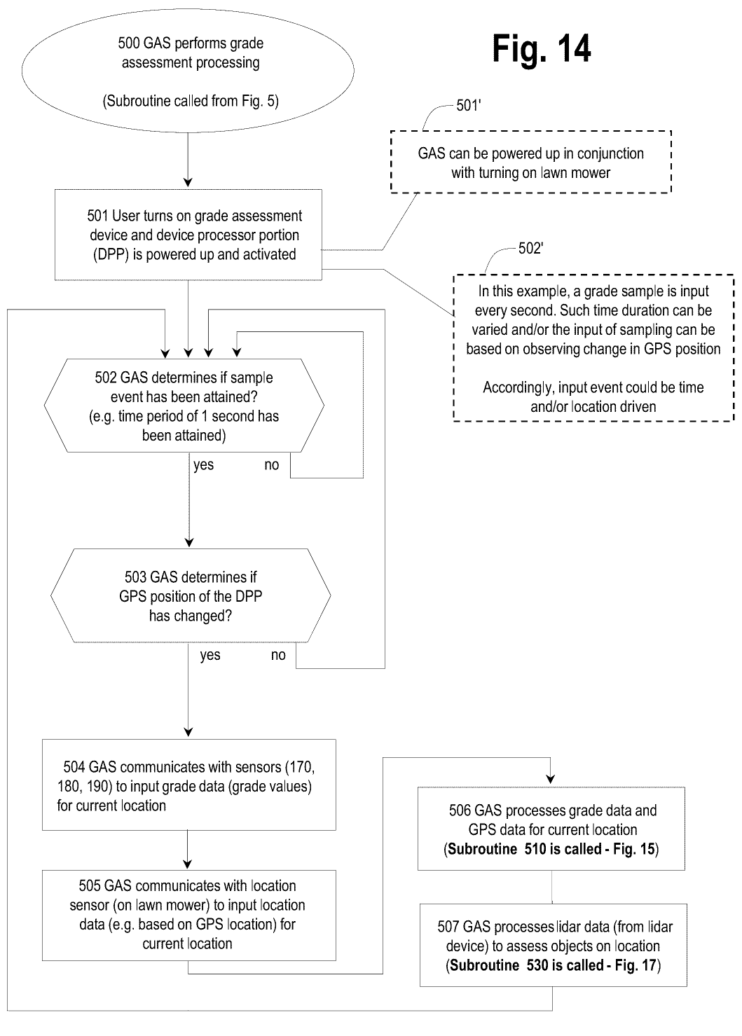

The DPP 155 can also include a general processing portion 151, a grade assessment setup portion 152, a grade assessment analysis portion 153, and a grade assessment recommendation portion 154. The general processing portion 151 can provide various general processing of the GAS device 150 including data maintenance, security related processing, and other general processing not handled by specialized processing portions of the GAS device 150. The grade assessment setup portion 152 can perform various processing related to the setup of a grade assessment including but not limited to set up of a grade assessment account for a user. Such processing can be illustrated in FIGS. 5-10, for example. The grade assessment analysis portion 153 can perform various processing related to the analysis of a grade assessment. Such analysis may include determining the grade of various areas of the lawn, for example. Such processing can be illustrated in FIGS. 14-17, for example.

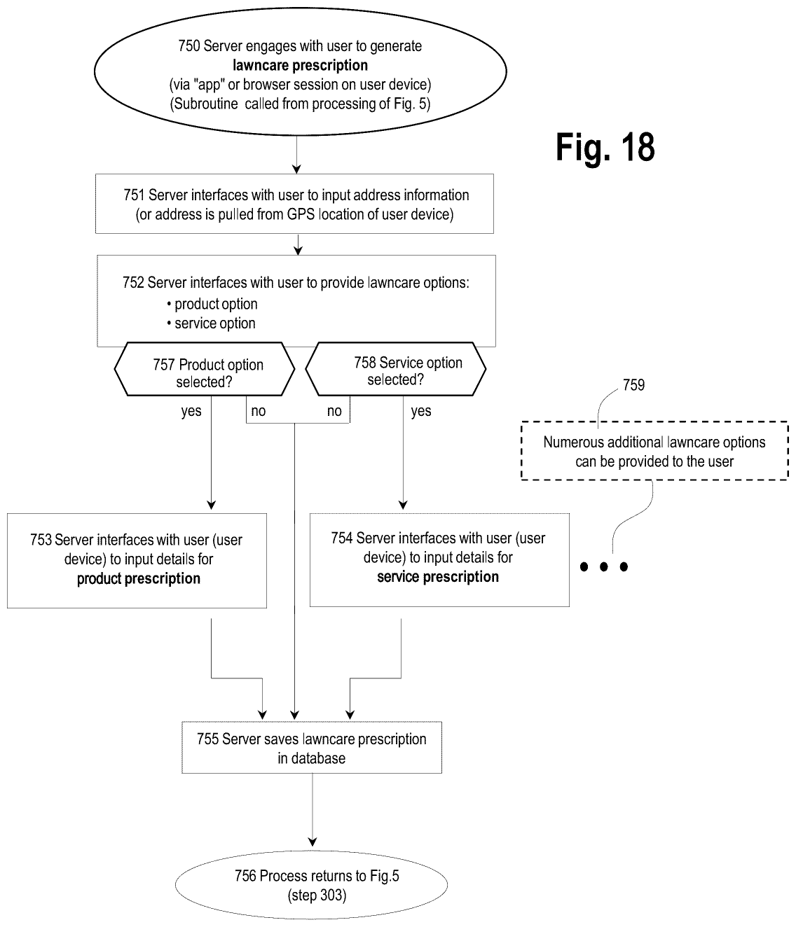

The grade assessment recommendation portion 154 can perform various processing related to the recommendation of a lawncare prescription based on the grade assessment of the lawn. Such recommendation may include where to remove material from the lawn to level out the grade of a particular area of the lawn so that the area's grade falls within a predetermined acceptable grade (also referred to as a predetermined acceptable grade range or predetermined grade threshold), for example. Such processing can be illustrated in FIGS. 18-19, for example.

The device database portion 160 can include a general database 161, a user database 162, a location database 163, and a recommendations database 164.

The general database 161 can store various data used by and/or generated by the general processing portion 151. The user database 162 can include various information regarding users of the GAS device 150. For example, the user database 162 can include credentials that allow a user to access the GAS device 150. The user database 162 might also include historical data of a user. Such historical data might include all the lawncare prescriptions that a particular user has created using the controller 110.

The device database portion 160 can also include the location database 163. The location database 163 can include various information regarding locations serviced by the GAS device 150, and other related data.

The location database 163 can also include the recommendations database 164. The recommendations database 164 can include various data that relates to recommendations for lawncare prescriptions. Accordingly, the recommendations database 164 can include data that represents tools, materials, supply stores, service providers, and rental equipment. The recommendations database 164 can also include data of nearby rental and/or seller facilities including but not limited to proximity, hours of operation, costs, advertising and/or promotional data. For example, the recommendations database 164 may include the price and customer review of a lawncare prescription for a neighboring lawn that was carried out by a service provider located within 5 miles of a user's location.

The GAS device 150 can also include a communication portion 145. The communication portion 145 can provide communication between the GAS device 150 and external entities or components. Communication can be performed over a network 136. For example, the communication portion 145 can communicate with a resource database(s) 137 over the network 136. The resource database 137 can provide, to the GAS device 150, the various resources, such as applicable topographic data, for example from the USGS database, that are used by the GAS device 150.

The GAS device 150 can include a GPS sensor 200 to receiving data related to the GPS coordinates of where the GAS device is located. The GPS sensor 150 can provide geocoordinates to the GAS device 150 for use in any of the processing of the GAS device 150 or the processing device 100 as a whole.

The mounting bracket 159 of the GAS device 150 can be any bracket suitable for mounting the GAS device 150 to any of the equipment 24, 26, or 28. The mounting bracket 159 can be specifically shaped to mount to lawnmowers, handheld lawn devices, garden tractors, ATVs, autonomous vehicles, or any other equipment that can movably transport the GAS device 150 around an area.

FIG. 5 is a high level chart showing “grade assessment system (GAS) 140 performs grade assessment processing” in accordance with principles of the disclosed subject matter. The processing of FIG. 5 can be initiated at step 300 and then pass on to any of steps 301, 302, or 303. This processing can be a subroutine of step 54 in FIG. 2.

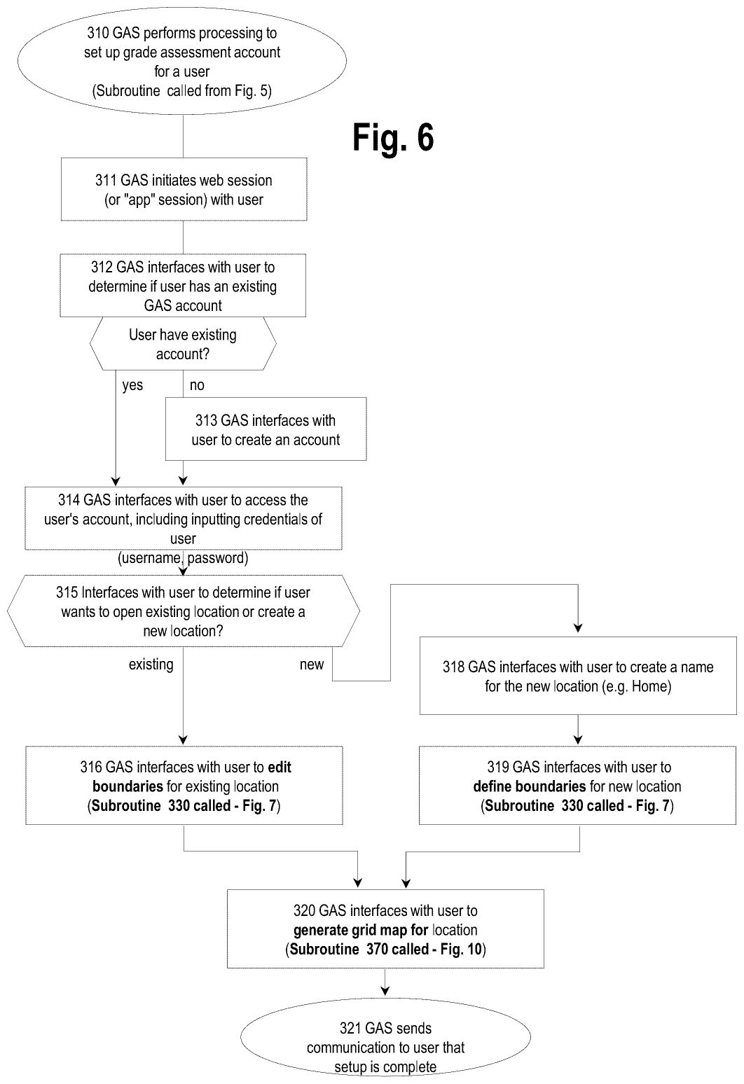

In step 301 the GAS 140 performs processing to set up a grade assessment account for a user. The server can engage with the user using a suitable interface such as an “app” or browser session on a user device. For example, the user device might be a cell phone. The GUI of FIG. 19, for example, can be generated by the server so as to interface with the user. To perform the processing of step 301, subroutine 310 can be called or invoked. Subroutine 310 is described below with reference to FIG. 6.

In step 302 the GAS 140 performs grade assessment processing of input data from location and performs analysis on the input data. To perform the processing of step 302, subroutine 500 can be called or invoked. Subroutine 500 is described below with reference to FIG. 14.

In step 303 the GAS 140 engages with the user to apply a lawncare prescription. The server can engage with the user using a suitable interface such as an “app” or browser session on a user device. For example, the user device might be a cell phone. The GUI of FIG. 19, for example, can be generated by the server so as to interface with the user. To perform the processing of step 303, subroutine 750 can be called or invoked. Subroutine 750 is described below with reference to FIG. 18.

FIG. 6 is a flowchart showing “GAS performs processing to set up grade assessment account for a user” of subroutine 310, in accordance with the principles of the disclosed subject matter. Such processing can include a user interfacing with the controller 110 via an app or browser session on a user device, for example. Subroutine 310 can be called or invoked from the processing of FIG. 5. As shown, the process starts in step 310 and passes onto step 311. In step 311, the GAS 140 initiates a web session or application session with the user. For example, the GAS 140 can engage with the user using a suitable interface such as an “app” of browser session on a user device. After step 311, the process passes onto step 312.

In step 312, the GAS 140 interfaces with the user to determine if the user has an existing GAS account. It may be the case that the user has an existing account, the process passes to step 314. In another implementation, it may be the case that the user does not have an existing GAS account. As a result, the process passes to step 313 and the GAS 140 interfaces with the user to create an account. The account can be associated with an e-mail address and a password of the user's choosing, for example. After the user has created a GAS account in step 313, the process passes onto step 314.

In step 314, the GAS 140 interfaces with the user to access the user's account including inputting the credentials associated with the user's GAS account. For example, a username and password associated with user's GAS account can be entered. When the username and password matching a GAS account are entered, the process can pass onto step 315.

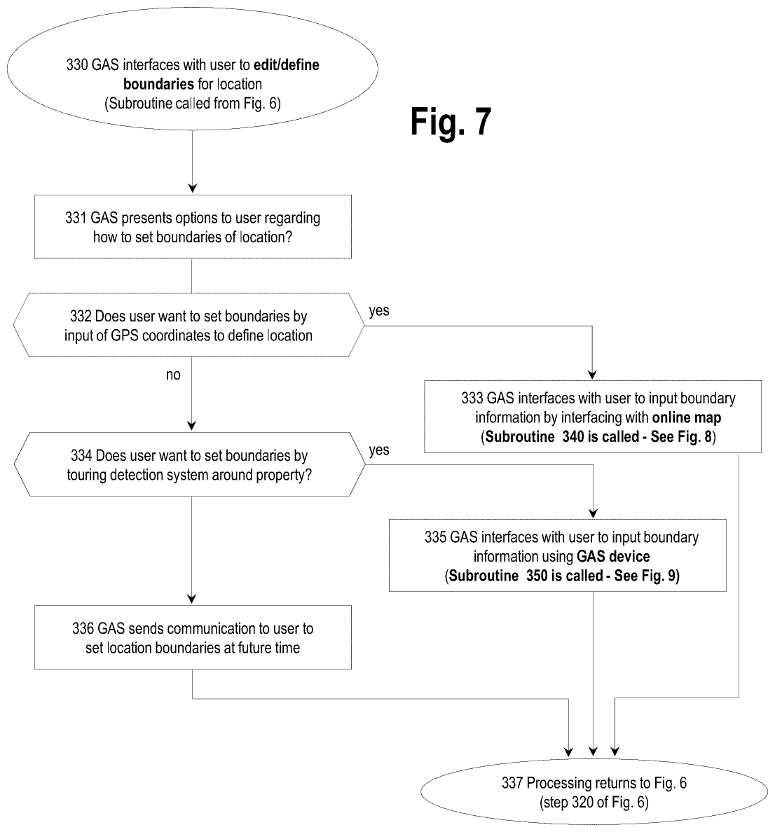

In step 315, the GAS 140 interfaces with the user to determine if the user wants to open an existing location or create a new location. It may be the case that the user wants to open an existing location. As a result, the process passes onto step 316. In step 316, the GAS 140 interfaces with the user, i.e., the user device, to edit boundaries for the existing location. To perform such processing, the GAS 140 can call or invoke subroutine 330. Subroutine 330 is illustratively described below with reference to FIG. 7.

In another implementation, it may be the case that the user wants to create a new location. As a result, the process passes onto step 318. In step 318, the GAS 140 interfaces with the user to create a name for the new location. For example, the user may name the new location “Home.” After step 318, the process can pass onto step 319. In step 319 the GAS 140 interfaces with the user to define boundaries for the new location. To perform such processing, the GAS 140 can call or invoke subroutine 330. Subroutine 330 is illustratively described below with reference to FIG. 7.

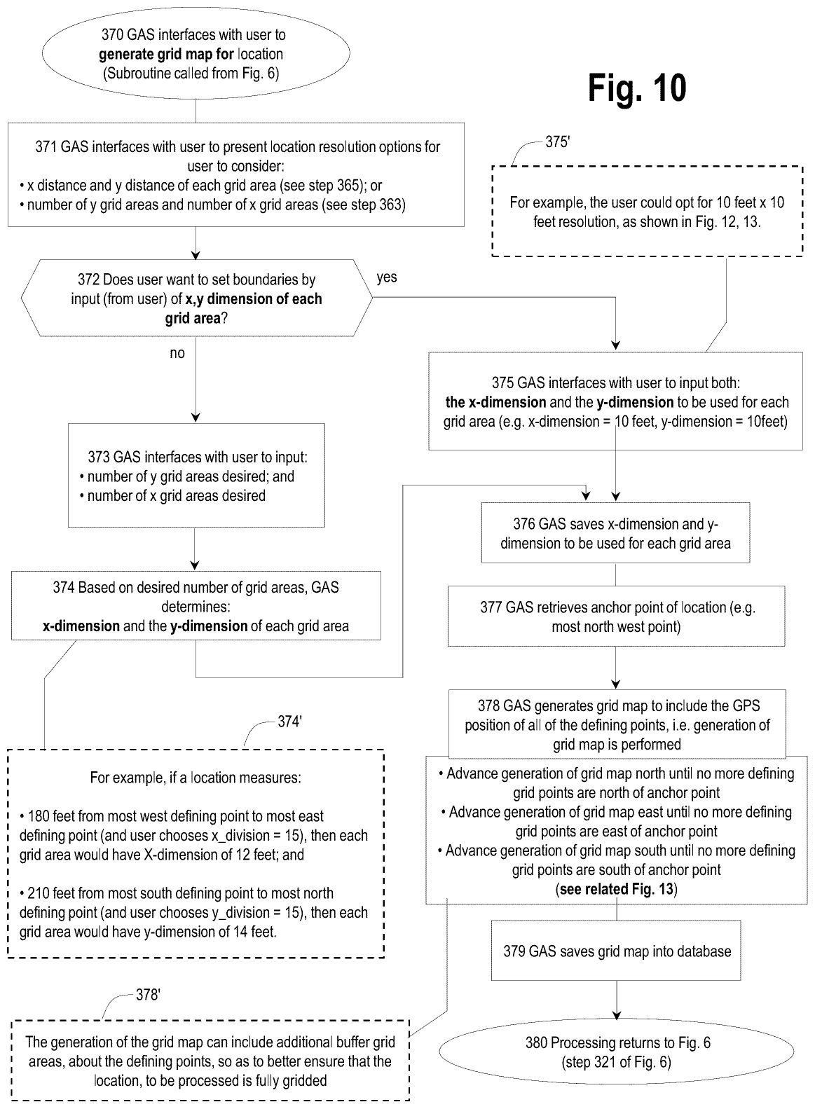

After either of step 316 or 319, the process passes onto step 320. In step 320, the GAS 140 interfaces with the user to generate a grid map for the location. To perform such processing, the GAS 140 can call or invoke subroutine 370. Subroutine 370 is illustratively described below with reference to FIG. 10. After step 320, the process passes onto step 321. In step 321, the GAS 140 sends communication to the user that the setup is complete.

FIG. 7 is a flowchart showing “GAS interfaces with user to edit/define boundaries for location” of subroutine 330, in accordance with the principles of the disclosed subject matter. Such processing can include a user interfacing with the controller 110 via an app or browser session on a user device, for example. Subroutine 330 can be called or invoked from the processing of FIG. 6. As shown, the process starts in step 330 and passes onto step 331.

In step 331, the GAS 140 presents options to the user regarding how to set boundaries of a location. For example, the GAS 140 may interface with the user for input through an “app” or browser session. After step 331, the process passes onto step 332.

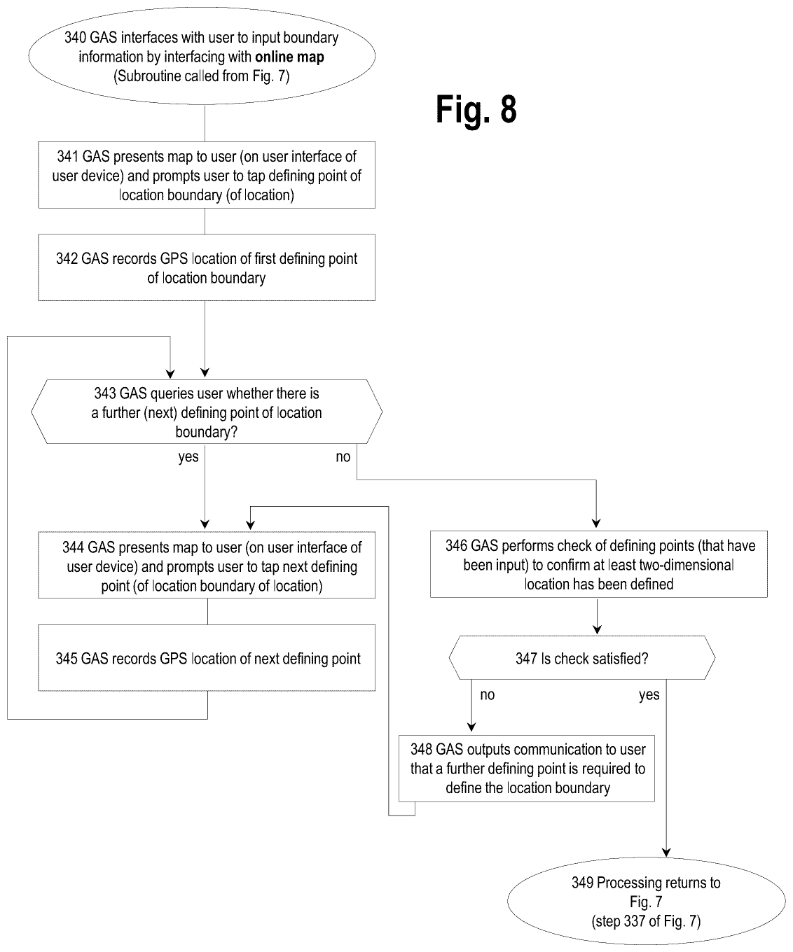

In step 332, the GAS 140 interfaces with the user to determine whether the user wants to set boundaries by input of GPS coordinates to define the location. It may be the case that the user wants to set boundaries by input of GPS coordinates. As a result, the process passes onto step 333. In step 333, the GAS 140 interfaces with the user to input boundary information by interfacing with an online map. To perform such processing, the GAS 140 can call or invoke subroutine 340. Subroutine 340 is illustratively described below with reference to FIG. 8.

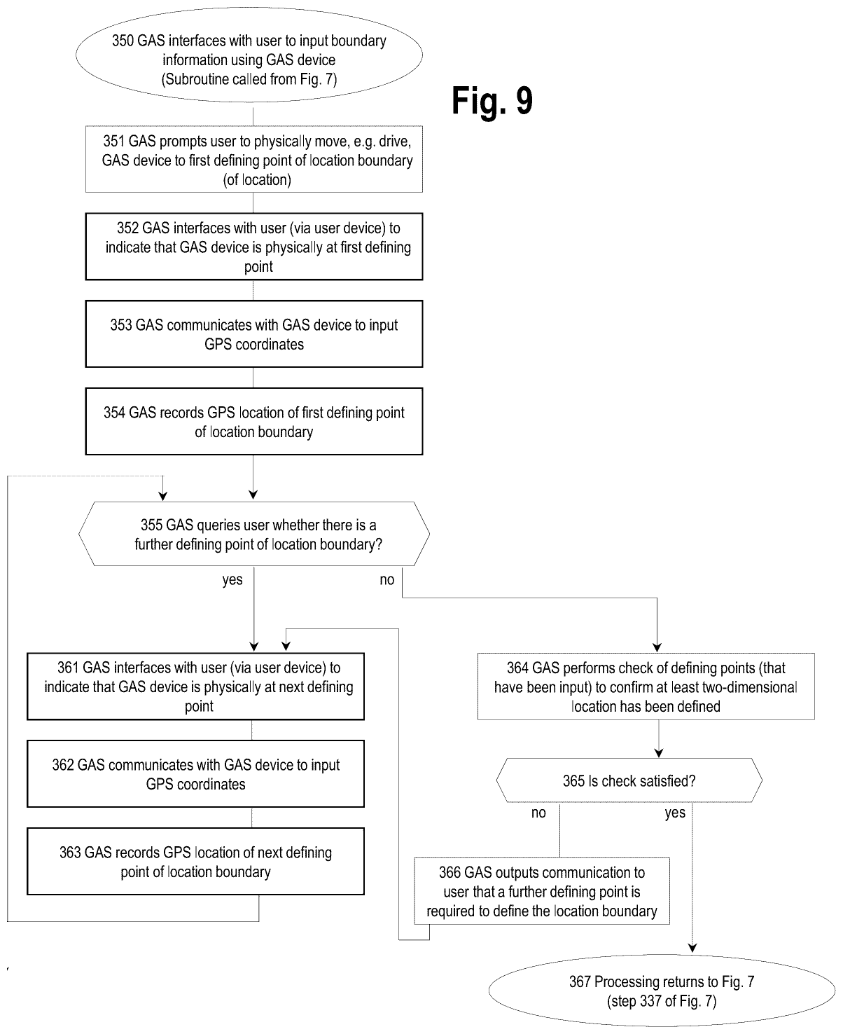

In another implementation, it may be the case at step 332 that the user does not want to set boundaries by input of GPS coordinates. As a result, the process passes onto step 334. In step 334, the GAS 140 interfaces with the user to determine whether the user wants to set boundaries by touring the detection system around the property. It may be the case that the user does want to set boundaries by touring the detection system around the property. As a result, the process passes onto step 335. In step 335, the GAS 140 interfaces with the user to input boundary information using the GAS device 150. To perform such processing, the GAS 140 can call or invoke subroutine 350. Subroutine 350 is illustratively described below with reference to FIG. 9.

In another implementation, it may be the case at step 334 that the user does not want to set boundaries by touring the detection system around the property. As a result, the process passes onto step 336. In step 336, the GAS 140 sends communication to the user to set location boundaries at a future time.

After any of steps 333, 335, or 336, the process passes onto step 337. In step 337, the process returns to FIG. 6 and illustratively passes onto step 320. However, as described above, the processing step 335 can be performed over a period of time. That is, step 335 can be performed days after, weeks after, or months after step 334. Also, step 335 can be repeated over a period of time.

FIG. 8 is a flowchart showing “GAS interfaces with a user to input boundary information by interfacing with an online map” of subroutine 340, in accordance with the principles of the disclosed subject matter. Such processing can include a user interfacing with the controller 110 via an app or browser session on a user device, for example. Subroutine 340 can be called or invoked from the processing of FIG. 7. As shown, the process starts in step 340 and passes onto step 341. In step 341, the GAS 140 presents a map to the user, for example on a user interface of a user device, and prompts the user to tap (or otherwise identify such as through clicking on a browser) a defining point of a location boundary of a location. After step 341, the process passes onto step 342.

In step 342, the GAS 140 records the GPS location of the first defining point of the location boundary. That is, the GAS 140 records the GPS location of the point that the user “tapped” on the user interface of the user device, for example. After step 342, the process passes onto step 343.

In step 343, the GAS 140 queries the user whether is a further (next) defining point of the location boundary. It may be the case that there is a further defining point of the location boundary. As a result, the process passes onto step 344. In step 344, the GAS 140 presents the map to the user and prompts the user to tap the next defining point of the location boundary of the location. After step 344, the process passes onto step 345. In step 345, the GAS 140 records the GPS location of the next defining point that was tapped or selected by the user. After step 345, the process passes onto step 343.

In another implementation, in step 343, it may be the case that there is not a further defining point of the location boundary. As a result, the process passes onto step 346. In step 346, the GAS 140 performs a check of the defining points (that have been input by the user) to confirm that at least a two-dimensional location has been defined. After step 346, the process passes onto step 347. In step 347, the GAS 140 determines whether the check of step 346 has been satisfied. It may be the case that the check is not satisfied. As a result, the process passes onto step 348. In step 348, the GAS 140 outputs communication to the user that a further defining point is required to define the location boundary. After step 348, the process passes onto step 344, described above. In another implementation, in step 347, it may be the case that the check of step 346 is satisfied. As a result, the process passes onto step 349. In step 349, the process returns to FIG. 7 and illustratively passes onto step 337.

FIG. 9 is a flowchart showing “GAS interfaces with user to input boundary information using GAS device” of subroutine 350, in accordance with the principles of the disclosed subject matter. Such processing can include a user interfacing with the controller 110 via an app or browser session on a user device, for example. Subroutine 350 can be called or invoked from the processing of FIG. 7. As shown, the process starts in step 350 and passes onto step 351. In step 351, the GAS 140 prompts the user to physically move, e.g., push, drive, or maneuver, the GAS device 150 to a first defining point of the location boundary of the location. After step 351, the process passes onto step 352. In step 352, the GAS 140 interfaces with the user to indicate that the GAS device 150 is physically at the first defining point. After step 352, the process passes onto step 353. In step 353, the GAS 140 communicates with the GAS device 150 to input GPS coordinates. After step 353, the process passes onto step 354. In step 354, the GAS 140 records GPS location of the first defining point of location boundary. After step 354, the process passes onto step 355.

In step 355, the GAS 140 queries the user whether there is a further defining point of location boundary. It may be that the case that there is a further defining point of the location boundary. As a result, the process passes onto step 361. In step 361, the GAS 140 interfaces with the user to indicate that the GAS device 150 is physically at the next defining point. After step 361, the process passes onto step 362. In step 362, the GAS 140 communicates with the GAS device 150 to input the GPS coordinates. After step 362, the process passes onto step 363. In step 363, the GAS 140 records the GPS location of the next defining point of the location boundary. After step 363, the process passes onto step 355.

In another implementation, in step 355, it may be the case that there is not a further defining point of the location boundary. As a result, the process passes onto step 364. In step 364, the GAS 140 performs a check of defining points that have been input to confirm that at least a two-dimensional location has been defined. After step 364, the process passes onto step 365. In step 365, the GAS 140 determines whether the check of step 364 has been satisfied. It may be the case that the check is not satisfied. As a result, the process passes onto step 366. In step 366, the GAS 140 outputs communication to the user that a further defining point is required to define the location boundary. After step 366, the process passes onto step 361, described above. In another implementation, in step 365, it may be the case that the check of step 364 is satisfied. As a result, the process passes onto step 367. In step 367, the process returns to FIG. 7 and illustratively passes onto step 337.

FIG. 10 is a flowchart showing “GAS interfaces with user to generate grid map for location” of subroutine 370, in accordance with the principles of the disclosed subject matter. Such processing can include a user interfacing with the controller 110 via an app or browser session on a user device, for example. Subroutine 370 can be called or invoked from the processing of FIG. 6. As shown, the process starts in step 370 and passes onto step 371. In step 371, the GAS 140 interfaces with the user to present location resolution options for the user to consider. For example, it may be the case that the user wants x distance and y distance of each grid area. Or, in another implementation it may be the case that the user wants a specific number of y grid areas and number of x grid areas. After step 371, the process passes onto step 372.

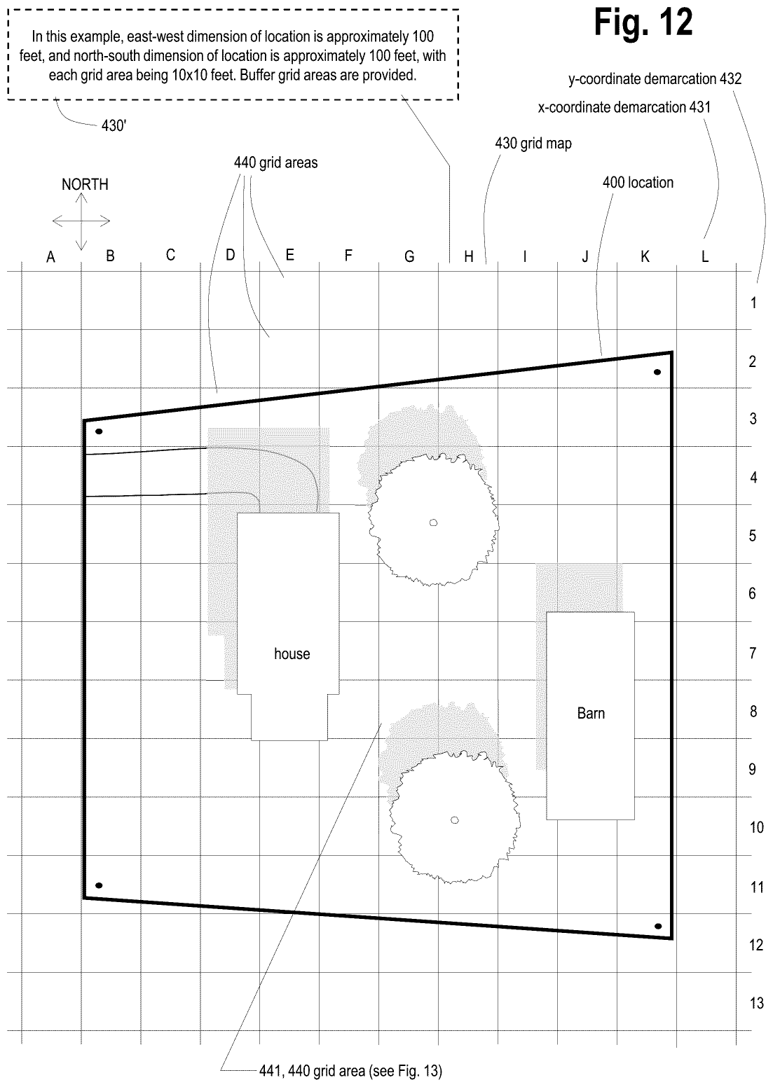

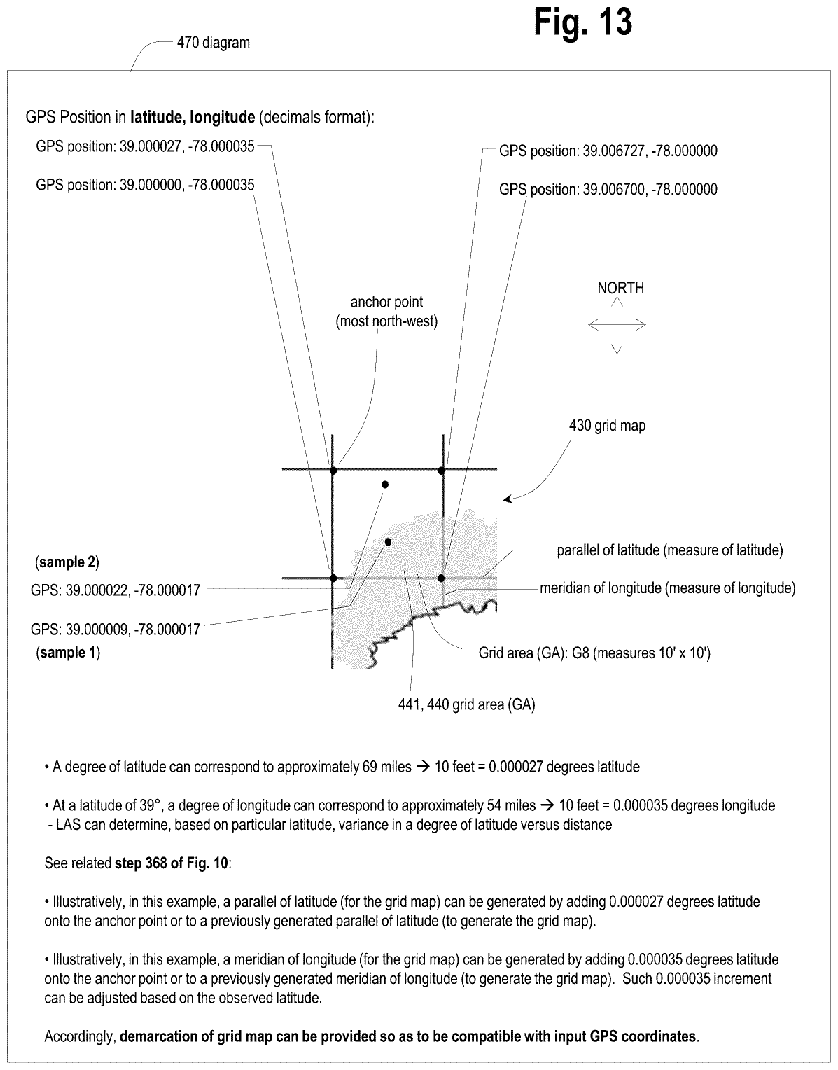

In step 372, the GAS 140 interfaces with the user to determine whether to set boundaries by input of x,y dimensions of each grid area. It may be the case that the user wants to set boundaries by inputting x,y dimensions of each grid area. As a result, the process passes onto step 375. In step 375, the GAS 140 interfaces with the user to input both the x-dimension and the y-dimension to be used for each grid area. For example, the user can input an x-dimension of 10 feet and a y-dimension of 10-feet. As reference in 375′, the 10 feet by 10 feet resolution is shown in FIGS. 12 and 13.

In another implementation of FIG. 10 at step 372, it may be the case that the user does not want to set boundaries by inputting x, y dimensions of each grid area. As a result, the process passes onto step 373. In step 373, the GAS 140 interfaces with the user to input a number of y grid areas desired and a number of x grid areas desired. After step 373, the process passes onto step 374.

In step 374, based on the number of grid areas desired as input by the user, in the user device for example, the GAS 140 determines the x-dimension and y-dimension of each grid area. For example, as referenced in 374′, is a location measures 180 feet from most west defining point to most east defining point and the user chooses x_division of 15, then each grid area would have x-dimension of 12 feet. If a location measures 210 feet from the most south defining point to the most north defining point and the user chooses y_division of 15, then each grid area would have a y-dimension of 14 feet.

After either step 374 or 375, the process passes onto step 376. In step 376, the GAS 140 saves the x-dimension and the y-dimension to be used for each grid area. The GAS 120 can save these dimensions in the location database 163 or the location database 123 of the controller 110, for example. After step 376, the process passes onto step 377.

In step 377, the GAS 140 retrieves an anchor point of the location. The anchor point can be the most north west point, for example. After step 377, the process passes onto step 378.

In step 378, the GAS 140 generates a grid map to include the GPS position of all the defining points. That is, the generation of the grid map is performed. This generation can include advancing the generation of the grip map north until no more defining grid points are north of the anchor point, advancing the generation of the grid map east until no more defining grid points are east of the anchor point, advancing the generation of the grip map south until no more defining grid points are south of the anchor point as referenced in FIG. 10. The advancement of grid points and generation of the grid map is illustrated in detail in FIG. 13. Additionally, with reference to 378′, the generation of the grid map can include additional buffer grid areas, about the defining points, so as to better ensure that the location to be processed is fully gridded. After step 378, the process passes onto step 379.

In step 379, the GAS 140 saves the grid map into the database. The GAS 140 can save the grip map into the location database 163, for example. After step 379, the process passes onto step 380. In step 380, the process returns to FIG. 6 and illustratively passes onto step 321.

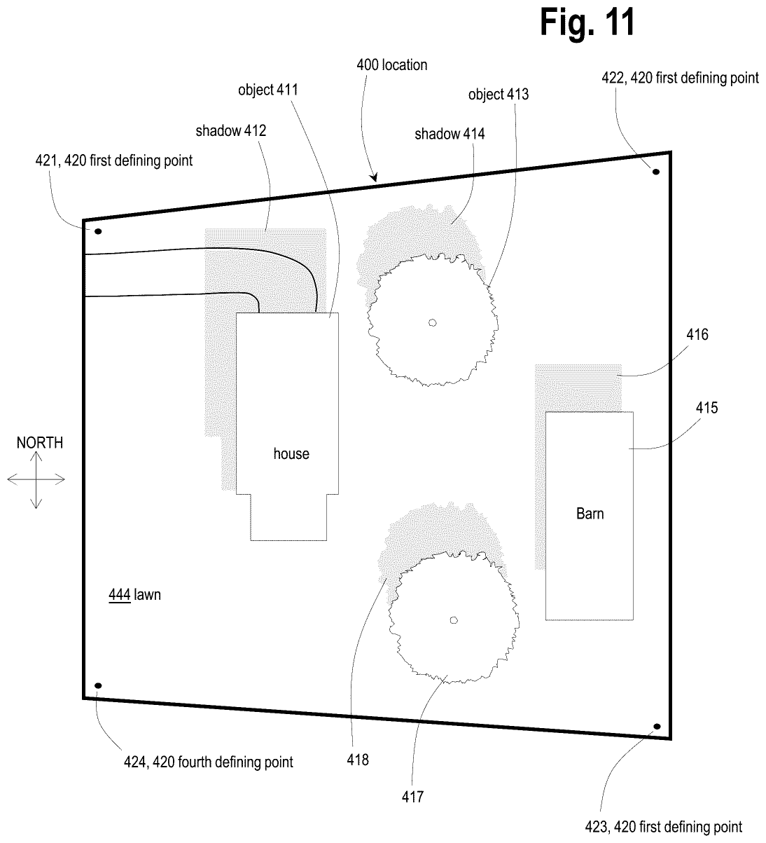

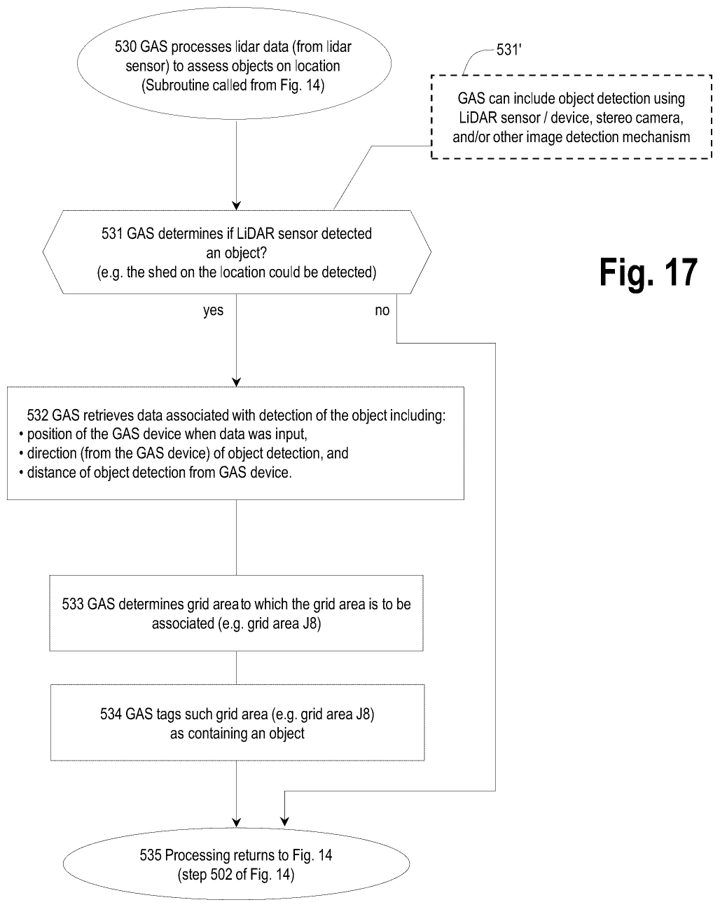

FIG. 11 illustrates a location 400 that a user has set boundaries for to define the location boundary using first defining points. The location 400 can include objects throughout the lawn 444 detected by lidar sensor 190 during the subroutine 530 described in detail below with respect to FIG. 17. Objects can include the house 411, trees 413 and 417, and the barn 415, for example. Shadows of the objects can be detected by sensors 170, 180 and 190 and mapped to location 400 as well such as shadows 412, 414, 418, and 416, for example. The location 400 can be geographically represented on North, South, East, and West orientation and defining points can be displayed. For example, a user may have selected a northwestern most boundary point with x, y coordinates 421, 420; a northeastern most boundary point with x, y coordinates 422, 420; a southwestern most boundary point with x, y coordinates 424, 420; and a southeastern most boundary point with x, y, coordinates 423, 420.

FIG. 12 illustrates the location 400 of FIG. 11 with a grid map 430 generated and overlayed thereon. The grid map 430 can include grid areas 440 that are labeled with x-coordinate demarcation 431 and y-coordinate demarcation 432. For example, FIG. 12 illustrates grid area 441, 440 labeled “G8” based on the x and y coordinate demarcations. Grid area G8 is described in detail below and illustrated with reference to FIG. 13. With reference to FIG. 12, the grid map 430 can include buffer grid areas surrounding the location 400.

FIG. 13 illustrates a diagram 470 of a grid area (GA) G8 from the grid map 430 of FIG. 12. The GA G8 can include an anchor point having a GPS position in latitude and longitude in the most north-west location of GA G8. A parallel of latitude and a meridian of longitude can be generated from the anchor point to generate the boundaries of the GA G8. In the example illustrated in FIG. 13, 0.000027 degrees latitude can be added to the anchor point, 0.000035 degrees longitude can be added to the anchor point, and both 0.000027 degrees latitude and 0.000035 degrees longitude can be added to the anchor point to determine the GPS position of the other boundary points of GA G8, respectively.

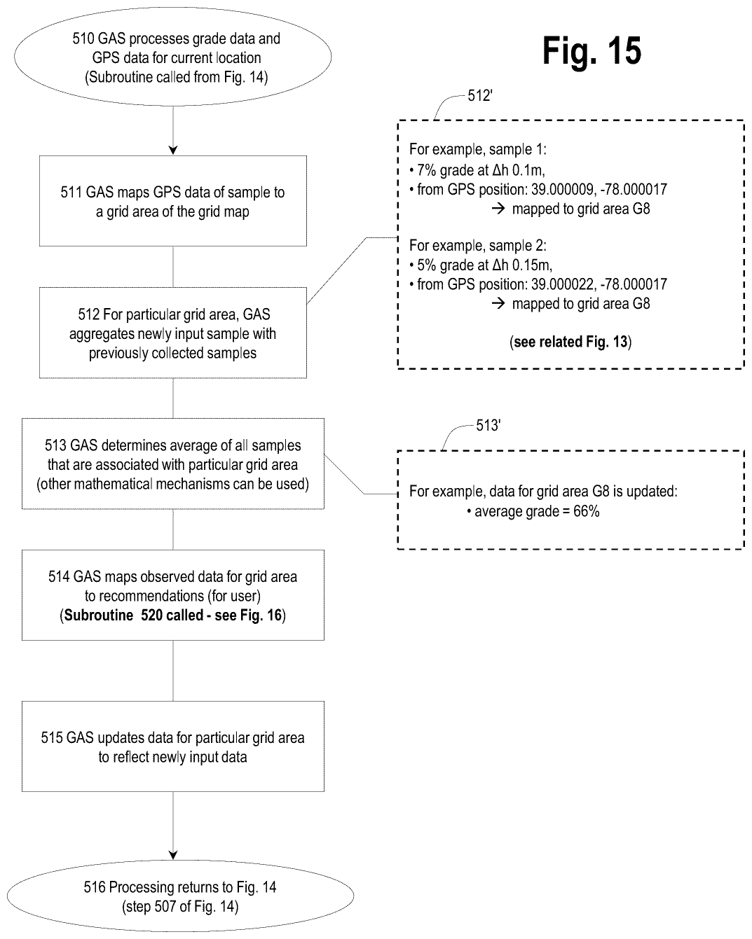

Additionally, sample 1 and sample 2 with respective GPS positions can be mapped to the GA G8. Sample 1 and sample 2 can be determined and mapped through the subroutine 510 discussed in detail below and illustrated in FIG. 15.

FIG. 14 is a flowchart showing “GAS performs assessment processing” of subroutine 500, in accordance with the principles of the disclosed subject matter. Such processing can include a user interfacing with the controller 110 via an app or browser session on a user device, for example. Subroutine 500 can be called or invoked from the processing of FIG. 5. As shown, the process starts in step 500 and passes onto step 501. In step 501, the user can turn on the GAS device 150 and the DPP 155 is powered up and activated. As referenced in 501′ the GAS device 150 can be powered up in conjunction with turning on the walk-behind machine 26, for example. After step 501, the process passes onto step 502.

In step 502, the GAS 140 determines if a sample event has been attained. The GAS 140 can check whether a sample event for a time period of 1 second has been attained, for example. Additionally, in the example illustrated in FIG. 14 at 502′, a grade sample can be input every second. The time duration of grade sample entries can be varied and/or input of sampling can be based on observing a change in GPS position. It may be case that a sample event has not been obtained. As a result, the process can return to step 502 after a passage of a time period to determine if a sample event has been attained. In another implementation, it may be the case that a sample event has been attained. As a result, the process passes onto step 503. In step 503, the GAS 140 determines if GPS position of the DPP 155 has changed. It may be the case that the GPS position of the DPP 155 has not changed. As a result, the process returns to step 502. In another implementation, it may be the case at step 503 that the GPS position of the DPP 155 has changed. As a result, the process passes onto step 504.

In step 504, the GAS 140 communicates with sensor, for example sensors 170, 180, and 190, to input grade data such as grade values for the current location. After step 504, the process passes onto step 505.

In step 505, the GAS 140 communicates with location sensors to input location data for the current location. The location sensors can be located on the GAS device 150 and/or the walk-behind machine 26, for example. The location data can be based on GPS location, for example. After step 505, the process passes onto step 506.

In step 506, the GAS 140 processes grade data and GPS data for the current location. To perform such processing, the GAS 140 can call or invoke subroutine 510. Subroutine 510 is illustratively described below with reference to FIG. 15. After step 506, the process passes onto step 507.

In step 507, the GAS 140 processes lidar data to assess objects on the location. To perform such processing, the GAS 140 can call or invoke subroutine 530. Subroutine 530 is illustratively described below with reference to FIG. 17. After step 507, the process passes onto step 502.

FIG. 15 is a flowchart showing “GAS processes grade data and GPS data for current location” of subroutine 510 of FIG. 14, in accordance with the principles of the disclosed subject matter. Subroutine 510 can be called from the processing of FIG. 14. As shown, the subroutine starts in step 510 and passes onto step 511. In step 511 the GAS 140 maps data of a sample to a grid area of the grid map. Then, the process passes onto step 512.

In step 512, for a particular grid area, the GAS 140 aggregates newly input samples with previously collected samples. For example, a sample 1 can include a calculated and/or measured 7% grade data point measured at Δh of 0.1 meters at GPS location 39.000009, −79.000017 that can be mapped to grid area G8 of FIG. 13, as reflected at 512′. Additionally, sample 2 can include a calculated and/or measured grade data point measured at Δh of 0.2 meters corresponding to a 5% grade at GPS coordinates 39.000002, −78.000017 that can be mapped to grid area G8 of FIG. 13. The Δh variable can be calculated or measured by comparing the altitude of the sample to an anchor point altitude. The anchor point altitude may be a maximum elevation for the location, a minimum elevation for the location, an elevation of the house 411, an elevation of the street near the location, or any other elevation of the location from which a relative change in elevation can be measured. After step 512, the process passes onto step 513.

In step 513, the GAS 140 determines the average of all samples that are associated with a particular grid area. For example, the data for grid area G8 of FIG. 13 can be updated to reflect an average grade of 6%, as reflected at 513′. Other mathematical mechanisms can be used instead of or in addition to an average. For example, grade data for a grid area can be represented by a collection of vectors, a median, a multimodal distribution, or any other mathematical mechanism for storing the grade data for a particular grid area. After step 513, the process passes onto step 514.

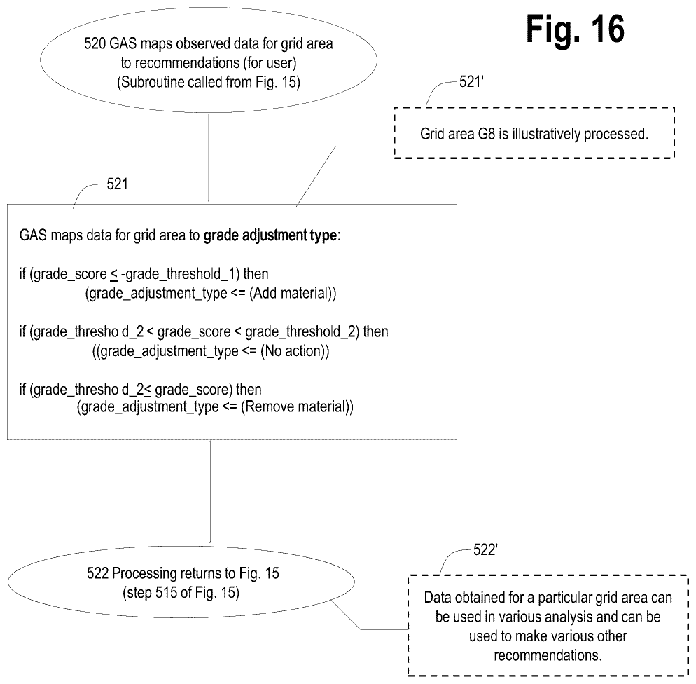

In step 514, the GAS 140 maps observed data for a grid area(s) to recommendations (for the user). To perform such processing, the GAS 140 can call or invoke subroutine 520. Subroutine 520 is illustratively described below with reference to FIG. 16. After step 514, the process passes onto step 515.

In step 515 the GAS 140 updates data for a particular grid area to reflect newly input data. After step 515, the process passes onto step 516. Processing then returns to the processing of FIG. 14, and passes to step 507 of FIG. 14 as described above.

FIG. 16 is a flowchart showing “GAS maps observed data for grid area to recommendations (for user)” of subroutine 520 of FIG. 15, in accordance with the principles of the disclosed subject matter. Subroutine 520 can be called from the processing of FIG. 15. As shown, the subroutine starts in step 520 and passes onto step 521. In step 521 the GAS maps data for a grid area to a grade adjustment type. Grade adjustment type can correspond to whether material should be added, material should be removed, or no action should be taken with respect to the lawn 444 for the grade adjustment. The grade adjustment types of “add material” and “remove material” can be mapped to grid areas that have a grade value not within a predetermined acceptable grade (exceeds the grade threshold). The predetermined acceptable grade can be a range of grade values. For example, in FIG. 15 the predetermined acceptable grade, that is the grade that would not need adjustment can be the grade range between grade_threshold_1 and grade_threshold_2. As illustrated for grid area G8 at 521′, if a grade score for a particular grid area is below or equal to grade_threshold_1, the grid area is mapped as a grade adjustment type “add material.” If the grade score for a particular grid area is between grade_threshold_1 and grade_threshold_2, the grid area is mapped as a grade adjustment type “no action.” If the grade score for the particular grid area is greater than grade_threshold_2, the grid area is mapped as a grade adjustment type “remove material.”

The predetermined grade threshold can include multiple variables. For example, the predetermined grade threshold can include a slope (or grade) threshold and an elevation change threshold, Δh_threshold.

The grade score can be a measurement of various grade data relative to an anchor point, or multiple anchor points, on the location to provide information about the grade of a grid area relative to adjacent grid areas and the location as a whole. For example, the grade score can be calculated by receiving grade profile data of the location. Grade profile data can be processed from a lawn image that is created based on the scanned data from the sensor array of the grade measurement device. Scanning can occur automatically via the various sensors incorporated in the GAS 140, but can also be accomplished manually (similar to surveying) at various waypoints by a user using separate sensing devices that can be networked to the system 100 or whose information can be input to the system 100 via a user interface 130. The grade profile data can include GPS coordinates, elevation, slope, change in height from an anchor point (relative elevation), a local minimum elevation, a local maximum elevation, the elevation in each corner of the grid area, the rise/run from the local minimum to each corner, and the rise/run from the local maximum to each corner.

Then, the grade profile data can be mapped to each of the plurality of grid areas of the location 400. Next, the grade profile data of each of the plurality of grid areas 440 can be compared to an anchor point grade profile. The anchor point grade profile can include grade profile data of various anchor points of the location, for example. The house 411 can be an anchor point, the street adjacent the location can be an anchor point, and the corners of the surrounding grid areas can be anchor points. Additionally, a location maximum and a location minimum can be anchor points. The location maximum can be the highest elevation point of the location 400, for example the at the house 411. The location minimum can be the lowest elevation point of the location 400, for example at the street. Each grid area 440 can also have a local maximum and a local minimum, that is the highest and lowest elevation points within each respective grid area.

The grade profile data of each of the grid areas 440 can be compared to various anchor points to determine whether the grid area is at a high point, low point, or slope of the lawn 444. By comparing the grade profile data of each grid area to its adjacent surrounding grid areas, the contours of the location lawn 444 can be determined. For example, a grid area may appear to be relatively flat when analyzed on its own, but when compared to the surrounding grid areas the grid area may be the bottom of a puddle forming spot of the lawn 444, for example. This could be determined by comparing the neighboring grade profile data and also the location minimum grade profile data to see that this particular grade area is at one of the lowest spots in the lawn 444, for example.

Calculating the grade score for each of the plurality of grid areas based on the respective grade profile data relative to the anchor point grade profile. Then, as illustrated in Step 521, for each of the plurality of grid areas, the GAS can determine whether to add or remove material to the grid area when the grade score for the grid area exceeds the predetermined grade threshold.

Step 521 can include additional considerations in combination with the predetermined grade threshold to determine the grade adjustment type. For example, determining whether to add or remove material to the grid area can also be based on variables such as, but not limited to, geographic data, almanac data, average rain fall for the location, peak rainfall for the time of year for the location, ten day forecast, or any other data that may affect the water run off and/or erosion of the material on the lawn 444. The GAS can also determine an amount of material to add or remove measured, for example, in volume so a user knows how much material to purchase, or in the case of removing material, how much carrying capacity will be sufficient to remove the material off location. The GAS can indicate where to add or remove the material within each grid of the plurality of grid areas.

After step 521, the process passes onto step 522. Processing then returns to the processing of FIG. 15, and passes to step 515 of FIG. 15 as described above. Additionally, as illustrated at 522′ the data obtained for a particular grid area can be used in various analysis and can be used to make various other recommendations and/or be displayed to a user through the GUI 921, for example.

FIG. 17 is a flowchart showing “GAS processes lidar data (from the lidar sensor) to assess objects on location” of subroutine 530 of FIG. 14, in accordance with the principles of the disclosed subject matter. Subroutine 530 can be called from the processing of FIG. 14. As shown, the subroutine starts in step 530 and passes onto step 531. In step 531 the GAS 140 determines if LiDAR sensor 190 detected an object. For example, the barn 415 on location 400 of FIG. 11 could be detected. The GAS 140 can include object detection by various mechanisms including but not limited to LiDar sensors or devices, stereo cameras, and/or other image detection mechanisms as illustrated at 531′. If the GAS 140 detects an object, the process can pass onto step 532. If the GAS 140 does not detect an object, the process can pass onto step 535 and processing then returns to the processing of FIG. 14 to step 502 as described above.

In step 532, the GAS 140 retrieves data associated with the detection of the object including, but not limited to, position of the GAS device 150 when data was input, direction (from the GAS device 150) of object detection, and distance of object detection from the GAS device 150. The GAS 140 can additionally capture any other available data including but not limited to, data from equipment 12, data from other sensors on the GAS device 150 or sensors that collect equipment data 12, and/or third-party data from resource database(s) 137. After step 532, the process passes onto step 533.

In step 533, the GAS 140 determines grid area to which the grid area of the object is to be associated. The object can be associated with more than one grid area if the object spans multiple grid areas. After step 533, the process passes onto step 534.

In step 534, the GAS 140 tags such grid areas as containing an object. Grid areas can contain one or more objects or no objects. After step 534, the process can pass onto step 535 and processing then returns to the processing of FIG. 14 to step 502 as described above.

FIG. 18 is a flowchart showing “server engages with user to generate lawncare prescription” of subroutine 750, in accordance with the principles of the disclosed subject matter. Such processing can include a user interfacing with the controller 110 via an app or browser session on a user device, for example. Subroutine 750 can be called from the processing of FIG. 5.

Relatedly, FIG. 19 is a further schematic diagram of the user device 920. The controller 110 can communicate with the user device 920 to present a GUI 921 on the user device. The GUI 921 can be utilized in the processing of FIG. 18, as described below.

With further reference to FIG. 18, the subroutine 750 can initiate and pass onto step 751. In step 751, the engine interfaces with the user to input address information of the location to be serviced. In an embodiment, the address information can be based on a GPS location of the user device 920, such as a GPS location of the user's smart phone, for example. In an embodiment, the text field 931 can be provided in the form of a drop-down menu. The drop-down menu can be populated with all the locations associated with the particular user. Relatedly, a user may be required to enter credentials, such as username and password, so as to access the GUI 921.

After step 751, the process passes onto step 752. the server interfaces with the user to provide lawncare options. Such lawncare options can include a wide variety of products and/or services, such as system services and products 30 or external services and products 40, for example. In the example of step 752, two lawncare options are provided including a product option 757 and a service option 758. Relatedly, in FIG. 19 the GUI 921 can include option windows 940 and 945. The option windows 940 and 945 can be generated on the user device 920 in a browser session with the controller 110. In this example, the option window 940 can provide functionality by which the user chooses between a “do it yourself” option and a “service provider” option. The server can display such options using the text field (or field) 941 and the field 942. The user can select an option by choosing one of the “radio buttons” 941′, 942′ on the left hand side of the option window 940. In the example of FIG. 19, the user has a do it yourself option, as displayed in the field 941. Additionally, in this example, the option window 945 can provide functionality by which the user chooses between various products 30, 40 and whether to rent or purchase the products 30, 40. The server can display such purchase or rental options using the option field (or dropdown fields) 946, 947, and 948. The user can select a product by choosing one of the “radio buttons” 946′, 947′, and 948′ on the left hand side of the option window 945. In the example of FIG. 19, the user selected to purchase a shovel, rent a tiller, and purchase topsoil, as displayed in the window 945. Additionally, the GUI 927 can include button 952 to add additional products that the user may desire to rent or purchase.

With further reference to FIG. 18, it may be the case that the user selects the service option. As a result, the process passes onto step 754. In step 754, the engine interfaces with the user, i.e., with the user device, to input details for generation of a service prescription.

In another implementation, it may be the case that the user selects the product option. As a result, the process passes onto step 753. In step 753, the engine interfaces with the user to input details for product acquisition.

The user may select both the product option and the service option in which case the engine interfaces with the user to input details for service prescription and product acquisition. Relatedly, FIG. 19 in option window 950 there is shown an example of a user that has selected the do it yourself service option and the product option. Option field 951 displays information about the date and time the user can retrieve the product.

As reflected at 759 of FIG. 18, it is appreciated that numerous additional lawncare options can be provided to the user. Illustratively, such additional options might include the analyzing neighboring topographical data and water-run off or generating a green-energy lawncare prescription, for example.

After either of step 753 or 754 (or if no option is selected, step 752) the process passes onto step 755. In step 755, the engine saves the lawncare prescription in a database. In particular, the lawncare prescription can be saved in location database 123. More specifically, a table or prescription table can be generated that contains the data of the prescription and that is associated with the particular geographical location.

After step 755, the process passes onto step 756. In step 756, the process returns to FIG. 5. However, as described above, the processing of step 301, step 302, and step 303 can be performed over a period of time. That is, step 302 might be performed days after, weeks after, or months after step 301. Also, steps 302 and 303 can be repeated over a period of time.

As described herein, the GUI 921, shown in FIG. 19, can provide various functionality for a user to generate a lawncare prescription. The GUI 921 can be presented on a suitable user device 920, such as a smart phone or tablet, for example. The GUI 921 can include field 931 that displays a geographical address for the service and field 932 that displays a section of the lawn such as front, back, side, etc. That is, a user can interface with the GUI 921, so as to enter the applicable address into the field 931 and the applicable section of the lawn into the field 932. Processing can then be performed based on the address displayed in the field 931. In particular, applicable resources, relating to available lawncare products and services and/or topographic data such as nearby water run-off, can be based on the address displayed in field 931. The field 931 can be in the form of a drop-down menu. For example, a particular user might have control over a number of locations. In particular, a lawncare professional or lawncare technician may have access to many locations. The user can be provided access all of such locations, and lawncare prescriptions that correspond to such locations, by changing the address in field 931. A user may be required to enter credentials in order to access the GUI 921 and other functionality described herein. For example, the user may be required to enter a username and password so as to access the GUI 921 of FIG. 19.

The option window 940 can be generated on the user device 920 in a browser session with the controller 110. The option window 940 can provide functionality by which the user chooses between a do-it-yourself (DIY) lawncare prescription and a service provider performing the lawncare prescription, as displayed in field 941 and 942, respectively, in the option window 940. The user can select an option by choosing one of the buttons 941′ and 942′ on the left-hand side of the option window 940.

The option window 945 can be generated on the user device 920 in a browser session with the controller 110. The option window 945 can provide functionality by which the user can choose what equipment is to be included in the lawncare prescription and whether the equipment will be purchased or rented for a time period corresponding to completing the lawncare prescription. The equipment can be input in any suitable manner. For example, the equipment can be generated by the controller 110 and displayed in a list format in option window 945 allowing the user to select which equipment the user desires to rent or purchase by selecting or de-selecting buttons 946′, 947′, and 948′, for example. Other mechanisms can also be used to input the equipment. Alternatively, the controller 110 can selected one or more equipment from a plurality of equipment and present the selected equipment to the user.

In the example of FIG. 19, the user has selected purchase in the option field 946, rental in the option field 947, and purchase in the option field 948. In an embodiment, a user can unselect equipment by clicking a respective selection boxes on the left-hand side of the option window 945, as shown in the GUI 921. For example, the user can unselect or deselect the equipment shovel by clicking the box 946′, i.e., so as to unselect such box 946′. Other GUI mechanisms can be used in such processing, as desired.

The GUI 921 also includes button 952. The button 952 can display “Click to add additional product”. Accordingly, the user can click the button 952 if the user wishes to be presented with additional products for consideration. Upon the button 952 being clicked by the user, the option window 945 can be expanded so as to accommodate the display of such additional product. However, it may be the situation that no additional products are available for the particular lawncare prescription. As a result, a pop-up or other communication can be generated so as to advise the user of such status, i.e., that no further products are available.

The option window 950 can be generated on the user device 920 in a browser session with the controller 110. The option window 950 can provide functionality by which the user can choose when to schedule picking up rental equipment and/or when to schedule a service provider to come to the user's location and perform the lawncare prescription on the lawn. The user can select an appropriate time and date for service and/or equipment pick up with option field 951. The user can select or deselect rental pick up with button 951′. If the user does not want to pick up the rental equipment or wants to go to a store to purchase items, the user can deselect button 951′. Additionally, the controller 110 can provide the user with a store location for picking up equipment. However, is a user wishes to go to a different store, the user can click on a link for “store locator” for example to change the location at which the user can pick up products. Button 954 can provide the user with the option of agreeing to the lawncare prescription and any terms of service that may be provided.

The lawncare prescription can be named utilizing text field 960. The user can enter the name of the lawncare prescription and then save and/or submit the lawncare prescription for example to the service provider and/or product store with all the data related to pick-up time and equipment, material, and or rental or purchase preferences.

The GUI 921 can also include menu options 925. The menu options 925 can provide the user access to other functionality described herein. The user device 920 can include known features, such as a speaker 923, the camera 922, a microphone 924, and other know features.

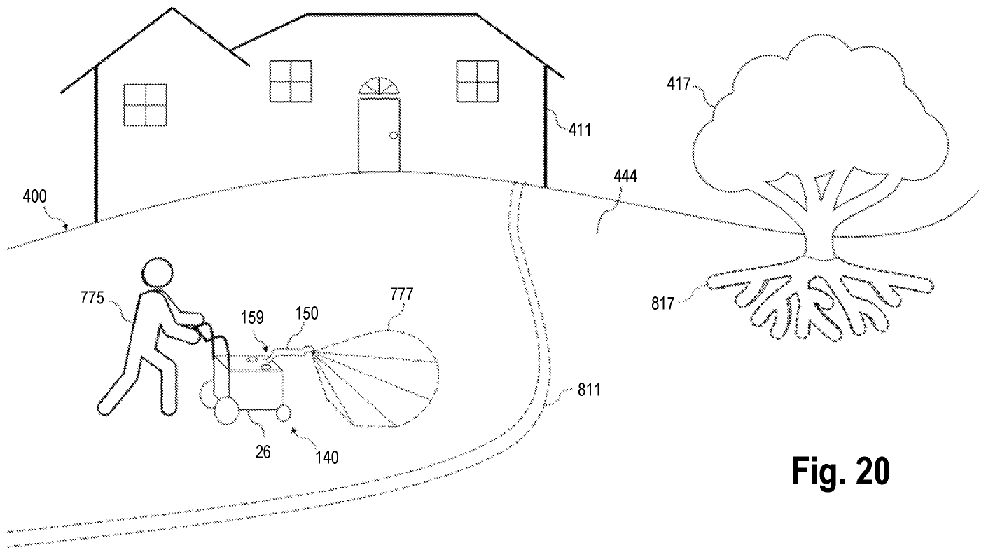

FIG. 20 illustrates a user 775 performing grade assessment using the GAS 140 at location 400 (which can also be referred to as the lawn). The GAS device 150 can be mounted on the walk-behind machine 26 via mounting bracket 159. The user 775 can propel the GAS device 150 around the lawn 444. The GAS device 150 can detect objects that are located above the surface of the lawn 444 such as the tree 417 and the house 411, and objects below the surface of the lawn 444 such as utility line 811 and roots 817.

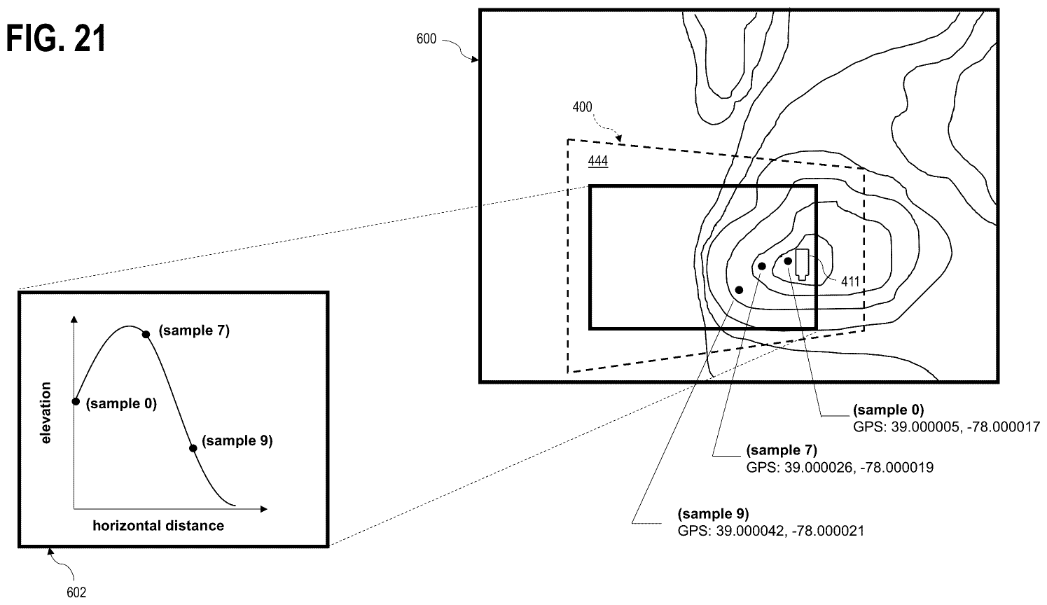

The GAS device 150 can be configured to scan the lawn 444 utilizing a plurality of sensors to emit and receive a scan 777 that can be used to form an image of the lawn 444 based on the scan data that can be utilized by the DPP 155 for processing. The scanned data can include a lawn image, sample points, grade data, GPS information correlated with map data, and other data acquired from the sensors that collectively can be referred to as lawn scan and mapping data 15. The sensor array (plurality of sensors) can include, but is not limited to, the top sensor 170 (camera), the side sensor 180, and the lidar sensor 190. Additionally, the GAS device 150 can determine the grade of the lawn 444 based on the scan data utilizing the grade assessment analysis portion 153 of the DPP 155. The GAS can also determine grade using typical surveying tools and through entry of grade/slope data by the surveyor into the user interface 130. Then, the GAS device 150 can determine whether material can be added or removed to the lawn 444 and where areas of the lawn may receive grade adjustment based on whether the grade data is within a predetermined range of grade values. The GAS device 150 can utilize the grade assessment recommendation portion 154 of the DPP 155 to make grade adjustment recommendations. The GAS device 150 can also be configured to communicate the recommendations to the network 136 or user device 131 by wired or wireless communication. The user device 131 can be configured to collect and display information regarding the lawn 44 during the grade assessment process. The collected and displayed information can include a topographic profile of the lawn and/or the results of the analysis of the lawn image from the grade assessment system 120. For example, FIG. 21 described in detail below displays an embodiment of grade data displayed in graphical form.

The GAS device 150 can be activated manually by actuating a power switch or activated wirelessly with the user device 131 utilizing a GUI, for example. Alternatively, the GAS device 150 can activate automatically when the walk-behind machine 26 is powered on or the GAS device 150 detects motion, for example.

FIG. 21 illustrates a schematic diagram of a topographic map 600 that can be generated by the GAS 140 as a result of the grade assessment processing subroutine of FIG. 14. The topographic map 600 can be displayed to a user on the user device 131, for example. The map 600 can be created by the GAS 140 as a result of aggregating data captured by the GAS device 150 while scanning the lawn 444 at location 400, including but not limited to data from the GAS device 150, sensor data 11, equipment data 12, GPS data 134, weather data 135, and/or data from resource databases 137. The map 600 can visually display the grade and contours of the lawn 444 to the user. Additionally, the map 600 can visually display objects such as the house 411.

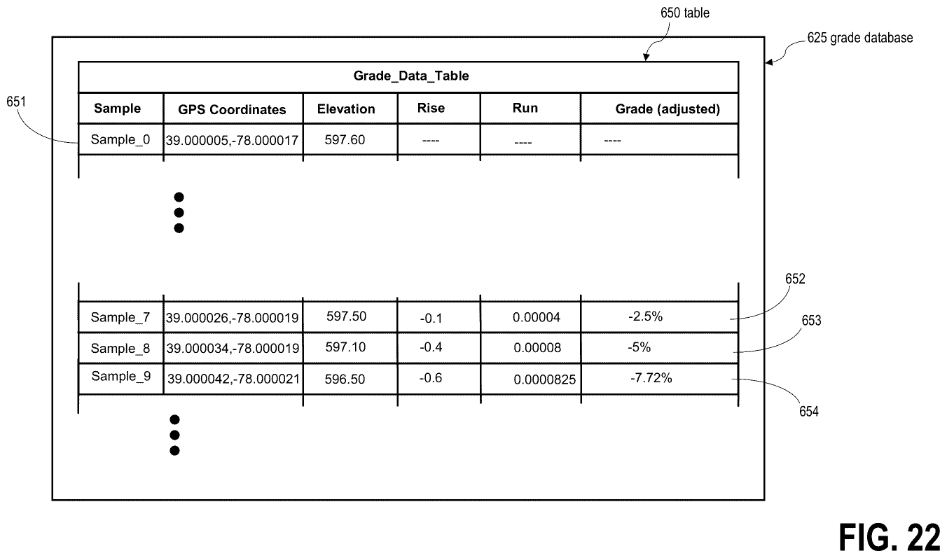

Specific areas of the lawn 444 can be expanded so the user may visually inspect areas of the lawn 444 that may be identified (whether by the GAS 140 or the user) for grade adjustment. For example, pop-out 602 displays a chart showing elevation of various sample points along a horizontal distance of the lawn 444. The sample data can include collected data samples from the GAS device 150 that are stored in the data table 650 shown in FIG. 22. Referring to the data in FIG. 21, there is shown sample data from samples such as sample 0, sample 7, and sample 9, for example.

FIG. 22 is a schematic diagram of a grade database 625 containing a grade data table 650 and various related data including grade data (also referred to as grade profile data), in accordance with the principles of the disclosed subject matter. The table 650 can include samples stored as reference records that include various data such as, but not limited to, GPS coordinates, elevation, rise, run, and grade. Rise, run, and grade can be calculated values based on the GPS coordinates and elevation of other references records. For example, the table 650 includes a reference record 651, titled “Sample_0” that corresponds to the first data point collected by the GAS device 150 when the user begins the grade assessment processing subroutine 500. Subsequent samples can be measured from the reference record 651. For example, record 652 titled “sample_7” can include calculated variables “rise” and “run” attained by a calculation of the difference between record 652, sample_7, elevation and GPS coordinates and elevation and GPS coordinates of reference record 651, sample_0. Records 652 and 653 can include similarly calculated values based on the reference record 651, or as shown in FIG. 22 based on preceding samples and the reference record 651. For consistency with previous examples, we note that FIG. 22 shows that sample_7 rise, run, and grade is the difference between sample_0 and sample_7. However, Samples 8 and 9 are the difference between their data and the immediately preceding entry.

The rise, run, and grade variables can be calculated in various manners and adjusted to various unit measurements. For example, the rise variable can be calculated by subtracting the elevation of a sample from the elevation of the immediately preceding sample. The run variable can be calculated by measuring the GPS distance between a sample and its immediately preceding sample. The grade variable can then be calculated by diving the rise variable by the run variable. Grade can also be referred to as slope, incline, gradient, mainfall, pitch or rise and can be expressed as an angle, percentage, ratio, or any other measure of grade.

The table 650 can also include other data relating to the grade assessment. For example, the table 650 can include time data, data that includes past application of the grade assessment, location specific data such as climate, soil type data, features of the lawn data related to terracing for example, and any other data that can relate to the grade assessment of a lawn. Any other data can be saved in the table 650 and the data structures of FIG. 22, as may be desired. A data record can be empty or null prior to being populated with data.

In processing of the grade database 625, data set forth in the grade database 625 can be retrieved by a call, by controller 110, to the particular table, which specifies the particular record, field and/or member within the particular table. Also, in processing, data can be written to a particular table by outputting the data to the particular table, and specifying the particular record, field and/or member (within the particular table) to which the data should be written, for example. It is appreciated that data, as described herein, may be stored in a database, retrieved from a database, and/or otherwise manipulated using known computer processing techniques. Further, it is appreciated that various additional data can be included in the table shown in FIG. 22, including any of the data described herein.

### ALTERNATIVE EMBODIMENTS

While certain embodiments of the invention are described above, it should be understood that the invention can be embodied and configured in many different ways without departing from the spirit and scope of the invention.

Embodiments above are disclosed in which the GAS device 150 is removably mounted to equipment or a walk-behind machine. However, embodiments are intended to also cover the GAS device 150 as a movable machine. That is the GAS device 150 can be an autonomous device such as a self-propelled device, a remote control device, or an integral piece of another movable device.

Embodiments above are disclosed in which Sample_0 is the first sample taken when a user begins the grade assessment. However, embodiments are intended to also cover implementations where Sample_0 can also refer to a base point of the lawn 444, such as where the house 411 is located for example. Any of the samples collected can be used as Sample_0. The processing can account for any Sample_0 point and calculate grade accordingly based on the other samples.

Various systems service and products 30 and external services and products can be recommended or offered to a user of the lawncare system 10. This can include suggested equipment 31, targeted sales leads 32, other services and products 33, fertilizer companies 41, landscapers 42, rental companies 43, automated services 44, and traditional services 45. Examples of products can include, but are not limited to, hand-held tools, power tools, shovels, tillers, dozer blades, all-terrain vehicles (ATV) dozer blades, lawn tractors, attachments for lawn tractors or ATVS, personal safety equipment such as helmets, googles, and gloves, or any other equipment for adjusting the grade of a lawn. The products can include materials such as dirt, gravel, topsoil, sand, seed, straw, or any other material that can be used to adjust the grade of a lawn. The material can be homogenous or mixed material. The material is not limited to fill material but may also include materials that can minimize the impact of erosion including but not limited to straw, hydromulch, wood and/or paper byproducts.

Grade adjustment described in embodiments above can be achieved through various methods. For example, the grade adjustment can include leveling peaks, adding material to fill in valleys, moving material from a first area to a second area, or any other method of adjusting grade.

An embodiment of the disclosed subject matter can include a CP or other server that is configured calculate how much area needs to be leveled for a particular project (i.e., determines correct grade portion(s) and incorrect grade portion(s) on a target property). The CP or server can then calculate how much material, such as dirt, would be required to correct the portion(s) deemed to be incorrectly sloped or graded. The system 10 is contemplated as including a device that can automatically spread the material, such as dirt or topsoil in accordance with calculated areas that require grade adjustment. For example, a dump or hopper type dispenser can be pulled behind a vehicle, such as a lawnmower or tractor, and can automatically dump material at selected locations where grade correction is desired while the tractor is either driven over the property by a user or is programmed to drive over the property or even remotely controlled to drive over the property. The system 10 can be programmed to ensure that more soil is dispensed closer to a house located on the target property to ensure proper water run off away from the house. The system 10 can also be configured to predict and address soil washout. For example, the system 10 can be configured to make grade change recommendations as well as fill material type recommendations in view of slope and other variables such as topography (trench structures are more susceptible to soil wash out). A material that is more likely to stick at the deposit or grade change location can be chosen for areas around a trench structure or area that have a history of soil wash out, or are otherwise determined to be susceptible to soil wash out. The system 10 can also be configured to cause grade change over a period of time by depositing materials at time increments, such as each time the grass is cut by a lawnmower. For example, the lawnmower or an attachment to the lawnmower can deposit material such as sand at predetermined locations determined by the system 10 while a user cuts their lawn each week. The system 10 can also seed while changing grade of particular areas to grow grass at the grade change location to prevent soil washaway. Thus, the automated system 10 can achieve gradient change as a gradual process, which is different from typical grade change operations where material is simply deposited at a single timing to immediately create gradient change. The system 10 can also have a development component along with an evaluation analysis component side. The development component would cause the system 10 to follow instructions set forth by a user (or determined or recommended initially by the system 10). The evaluation analysis component side of the system 10 would then analyze the property to see whether the development component is successfully arriving at a pre-set goal for the landscape geometry or grade change for the property and then recommend changes to the development plan.

The predetermined acceptable grade can account for various types of lawns and lawn features. For example, the predetermined acceptable grade can account for, or filter out, terraced features that are designed to have a particular grade that may be higher than the predetermined acceptable grade for other areas of the lawn. Additionally, the predetermined acceptable grade can be a single value, a range of grade values, or multiple ranges of grade values. For example, there can be multiple ranges of predetermined acceptable grade values corresponding to different recommendations. Such as a predetermined acceptable grade range that signifies urgent need of grade adjustment if outside the range, a predetermined acceptable grade range that signifies acceptable within range but may benefit from adjustment, etc.

The grade assessment recommendation portion 154 can be configured to calculate total material needed for grade adjustment based on an aggregate volume of all the areas of the lawn 444. For example, the grade assessment recommendation portion 154 can determine how much material needs to be added to the lawn for grade adjustment and how much material needs to be removed from the lawn for grade adjustment and determine whether the material to be removed can be relocated and/or used to add material to other areas of the lawn. Then, the grade assessment recommendation portion 154 can determine whether the material to be removed exceeds the material to be added and determine whether additional material needs to be acquired for the grade adjustment.

The resource databases 134 can include various data from third party sources including, but not limited to, neighboring topographic data, USGS data, water run-off data, nearby streams, creeks, and rivers, rainfall data, erosion data, and any other data that can affect water-run off towards, at, and away from the lawn 444 of the user.

Sensors can include various types of sensors and/or smart sensors. For example, tilt sensors of a lawnmower can gather data that can be used in the calculation of slope and/or contour of a lawn. The sensors of the sensor array can be directly on the GAS device 150, on any of the equipment 12, or a combination thereof. For example, a tilt sensor on a ride-on machine 28 can communicate wirelessly with the GAS device 150 mounted on the ride-on machine 28. The GAS 150 can aggregate the data from the tilt sensor as well as an accelerometer of the ride-on machine 28 with data from the GAS device's 150 sensors 170, 180, and 190 to create a set of grade data.

The grade measurement device can also be a standalone device that includes its own GPS link. Prior to beginning the grade adjustment processes described above, a user can be prompted to scan the lawn, tag locations such as the house, driveway, or street, and walk around the perimeter of the location. The user can be prompted to stand in the highest point and the lowest point of the lawn with the grade measurement device. The grade measurement device may also be entirely encompassed within a mobile user device having the scanning sensors built therein such that a user may only have to walk or drive the mobile device around the location to create the lawn image, map of the grid areas, and gather grade profile data.

Ride-on machines can refer to, but is not limited to, zero-turn lawnmowers and garden tractors.

Calculation of the grade score can include further mathematical processing and is not limited to the implementation described above. For example, calculating the grade score can include comparing and/or measuring the change in elevation for each grid area of the local maximum to each corner anchor point of the grid area, the local maximum to the location maximum anchor point, each corner anchor point to the location maximum anchor point, the local maximum to each corner anchor point of all (eight) adjacent surrounding grid areas, and then calculating the rise/run from each of these points to the other to determine the grade score.

Embodiments above are intended to include a battery that can provide power so as to power the various components of the GAS 140. The battery can be a rechargeable battery or exchangeable (for a new battery) upon exhaustion of the battery. Any system, device, apparatus or other construct described herein can be provided with a suitable power source. Additionally, any processor of the system that is mounted on an electric lawnmower can also plug into the battery of the lawnmower for electrical power and can be in electrical communication (wired or wireless) with the lawnmower processor(s) and/or sensor(s).

As described herein, in at least some embodiments of the system of the disclosure, various processes are described as being performed by one or more computer processors. Such one or more computer processors can, in conjunction with a database or other data storage mechanism, provide and/or constitute a “processing machine,” i.e., a tangibly embodied machine, in that such one or more computer processors can include various physical computing devices as otherwise described herein, various support structure to physically support the computing devices, other hardware, and other physical structure, for example. In embodiments, a processing machine of the disclosure can include one or more computer processors and one or more databases that are in communication with the one or more computer processors. A computer processor or processing machine of the disclosure can be part of a higher level system or apparatus.

As used herein, the term “computer processor” can be understood to include at least one processor that uses at least one memory. The at least one memory can store a set of instructions. The instructions may be either permanently or temporarily stored in the memory or memories of the processing machine or associated with the processing machine. The computer processor can execute the instructions that are stored in the memory or memories in order to process data, input data, output data, and perform related processing. The set of instructions may include various instructions that perform a particular task or tasks, such as any of the processing as described herein. Such a set of instructions for performing a particular task may be described as a program, software program, code or simply software. Accordingly, various processing is described herein as performed by a computer processor (CP). Such computer processor (CP) can be described as or can include: a computer processor portion, a computer processing portion, a processor, a system processor, a processing system, a server, a server processing portion, an engine, a processing engine, a central processing unit (CPU), a controller, a processor-based controller, an electronic computing device, an apparatus controller, an apparatus computer processor, a processing device, a computer operating system, an apparatus processing portion, an apparatus processing portion, an electronic control unit (“ECU”), a microcontroller, a microcomputer, a plurality of electronic computing devices or servers, other processor-based controller(s), and/or similar constructs, for example.

A computer processor and/or processing machine, of the disclosure, may be constituted by and/or be part of particular apparatus(es), system(s) and/or device(s) described herein. The computer processor can execute instructions that are stored in memory or memories to process data. This processing of data may be in response to commands by a user or users of the computer processor, in response to previous processing, in response to a request by another processing machine and/or any other input, for example. A user can be in the form of a user device, such as a cellular phone.

A computer processor and/or processing machine of the disclosure may also utilize (or be in the form of) any of a wide variety of technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that can be capable of implementing the steps of the processes of the disclosure.

The computer processor and/or processing machine used to implement the disclosure may utilize a suitable operating system. Thus, embodiments of the disclosure may include a processing machine running the Windows 11 operating system, the Windows 10 operating system, the Windows 8 operating system, Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the disclosure as described herein, it is not necessary that the computer processors and/or the memories of a processing machine be physically located in the same geographical place. That is, each of the computer processors and the memories used by the processing machine may be located in geographically distinct locations and connected so as to communicate in any suitable manner. Additionally, it is appreciated that each computer processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above can be performed by various components and various memories. However, it is appreciated that the processing performed by two distinct components as described herein may, in accordance with a further embodiment of the disclosure, be performed by a single component. Further, the processing performed by one distinct component as described above may be performed by two distinct components. For example, processing as described herein might be performed in part by a system or other system or server, in part by some third party resource, and in part by a user device. In a similar manner, the memory storage performed by two distinct memory portions as described herein may, in accordance with a further embodiment of the disclosure, be performed by a single memory portion. Further, the memory storage performed by one distinct memory portion as described above may be performed by two memory portions.

Further, as described herein, various technologies may be used to provide communication between the various processors and/or memories, as well as to allow the processors and/or the memories of the disclosure to communicate with any other entity; i.e., so as to obtain further instructions, transfer data, or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described herein, a set of instructions can be used in the processing of the disclosure on the processing machine, for example. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

It is appreciated that the instructions or set of instructions used in the implementation and operation of features of the disclosure may be in a suitable form such that a computer processor or processing machine may read the instructions. For example, the instructions that form a program may be in the form of a suitable programming language, which can be converted to machine language or object code to allow the processor or processors to read the instructions. That is, written lines of programming code or source code, in a particular programming language, can be converted to machine language using a compiler, assembler or interpreter. The machine language can be binary coded machine instructions that are specific to a particular type of processing machine, i.e., to a particular type of computer processor, for example. The computer processor understands the machine language.

Accordingly, a suitable programming language may be used in accordance with the various embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, Python, Ruby, PHP, Perl, JavaScript, and/or other scripting language, for example. Further, it is not necessary that a single type of instructions or single programming language be utilized in conjunction with the operation of the systems and methods of the disclosure. Rather, any number of different programming languages may be utilized as may be necessary or desirable.

Also, the instructions and/or data used in the practice of the disclosure may utilize any compression or encryption technique or algorithm, as may be desired. An encryption module might be used to encrypt data. Further, files or other data may be decrypted using a suitable decryption module, for example. Accordingly, a compression or encryption technique or algorithm can be used that transforms the data from an un-encrypted format to an encrypted format.

As described above, the disclosure may illustratively be embodied in the form of a processing machine, including a computer processor, for example, that includes at least one memory. It is to be appreciated that the set of instructions, i.e., the software for example, that enables the computer processor to perform the operations described herein may be contained on any of a wide variety of media or medium, as desired. Further, the data that can be processed by the set of instructions can be contained on any of a wide variety of media or medium. That is, the particular medium, i.e., the memory or data storage device used in a processing machine, utilized to hold the set of instructions and/or the data used in practice of the disclosure may take on any of a variety of physical forms or transmissions, for example. Illustratively, the medium or data storage device may be in a tangibly embodied form of paper, paper transparencies, a compact disk, a DVD, an integrated circuit, a hard disk, a floppy disk, an optical disk, a magnetic tape, a RAM, a ROM, a PROM, a EPROM, a CD-ROM, a DVD-ROM, a hard drive, a magnetic tape cassette, a wire, a cable, a fiber, communications channel, and/or may be in the form of a satellite transmissions or other remote transmission, as well as any other medium or source of data that may be read by the processors of the disclosure.

For example, exemplary embodiments are intended to cover all software or computer programs capable of enabling processors to implement the operations, designs and determinations as described herein. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed herein.

These computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs and outputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. A network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

The database(s), memory or memories used in the processing machine that implements the disclosure may be in any of a wide variety of forms to allow the memory to hold instructions, data, or other information, as can be desired. Thus, a memory might be in the form of a database to hold data. The database might use any desired arrangement of files or data sets such as a flat file arrangement or a relational database arrangement, for example. The database can include any number of data records, tables, and/or other data structure. A table in a database can include a Primary key (PK) to identify the table. A foreign key (FK) can be an attribute in one table (entity) that links or maps to the PK of another table, so as to provide an interrelationship or mapping between tables and/or databases, for example.

In various processing described herein and illustrated by flowcharts or otherwise described, variables can be used in various processes. Such processes can include routines, subroutines, and steps, for example. The various variables can be passed between processes as may be needed in accord with the instructions provided to a processor. The various variables can be global variables that are available to the various processes, such as between a calling process and a subroutine, for example.

In the system and method of the disclosure, a variety of “user interfaces” may be utilized to allow a user to interface with the processing machine or machines that are used to implement the disclosure. As used herein, a user interface can include any hardware, software, or combination of hardware and software used by the processing machine that allows a user to interact with the processing machine and/or computer processor. A user interface may be in the form of a dialogue screen for example. A user interface may also include any of a mouse, touch screen, keyboard, voice reader, voice recognizer, dialogue screen, menu box, list, checkbox, toggle switch, a light, a pushbutton or any other device that allows a user to receive information regarding the operation of the processing machine as the processing machine processes a set of instructions and/or provide the processing machine with information. Accordingly, the user interface can be any device that provides communication between a user and a processing machine and/or computer processor. The information provided by the user to the processing machine through the user interface may be in the form of a command, a selection of data, or some other input, for example.

A user interface of the disclosure can be provided by or in the form of a user device or electronic user device. Also, systems of the disclosure can include or be in communication with one or more user devices that serve to interact or interface with a human user. A user device can be any appropriate electronic device, such as a cellular (mobile) telephone, smart phone, a tablet computer, a laptop computer, a desktop computer, an e-reader, an electronic wearable, smartwatch, gaming console, personal digital assistant (PDA), portable music player, fitness trackers with smart capabilities, and/or a server terminal, for example.

Such a user device can permit a user to input requests for information, output information, and/or process data. A user device can be in the form of and/or include a computer processor and/or a processing machine, as described herein.

As discussed above, a user interface can be utilized by the processing machine, which performs a set of instructions, such that the processing machine processes data for a user. The user interface can be typically used by the processing machine for interacting with a user either to convey information or receive information from the user. However, it should be appreciated that in accordance with some embodiments of the systems and methods of the disclosure, it is not necessary that a human user actually interact with a user interface used by the processing machine of the disclosure. Rather, it is also contemplated that the user interface of the disclosure might interact, i.e., convey and receive information, with another processing machine, rather than a human user. Accordingly, the other processing machine might be described as a user. Further, it is contemplated that a user interface utilized in the systems and methods of the disclosure may interact partially with another processing machine or processing machines, while also interacting partially with a human user.

Features as disclosed herein may be described in context of particular units or dimensions. It is appreciated that alternative units or dimensions can be used as desired. Additionally, conversion can be performed between units or dimensions as may be desired.

In this disclosure, quotation marks, such as with the language “computer processor”, have been used to enhance readability and/or to parse out a term or phrase for clarity.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, process step, region, layer or section from another region, layer or section. Thus, a first element, component, process step, region, layer or section could be termed a second element, component, process step, region, layer or section without departing from the teachings of the present disclosure.

Spatially and organizationally relative terms, such as “lower”, “upper”, “top”, “bottom”, “left”, “right”, “north”, “south”, “east”, “west”, “up”, “down”, “right”, “left”, “upper threshold”, “lower threshold” and the like, may be used herein for ease of description to describe the relationship of one element or feature to another element(s) or feature(s) as illustrated in the drawing figures. It will be understood that spatially and organizationally relative terms are intended to encompass different orientations of or organizational aspects of components in use or in operation, in addition to the orientation or particular organization depicted in the drawing figures. For example, if a device or apparatus in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

Embodiments are also intended to include or otherwise cover methods of using and methods of manufacturing any and all of the elements disclosed above.

As used herein, “data” and “information” have been used interchangeably.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, process steps, operations, elements, and/or components, but do not preclude the presence or addition of one or more other features, integers, process steps, operations, elements, components, and/or groups thereof.

Embodiments of the disclosure are described herein with reference to diagrams, flowcharts and/or other illustrations, for example, that are schematic illustrations of idealized embodiments (and intermediate components) of the disclosure. As such, variations from the illustrations are to be expected. Thus, embodiments of the disclosure should not be construed as limited to the particular organizational depiction of components and/or processing illustrated herein but are to include deviations in organization of components and/or processing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

While the subject matter has been described in detail with reference to exemplary embodiments thereof, it will be apparent to one skilled in the art that various changes can be made, and equivalents employed, without departing from the scope of the disclosure.

All references and/or documents referenced herein are hereby incorporated by reference in their entirety.

It will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A system to assess a lawn slope to control water runoff and chemical concentrations at a location, the system including a tangibly embodied computer processor (CP) and a tangibly embodied database, the CP implementing instructions on a non-transitory computer medium disposed in the database, and the database in communication with the CP, the system comprising:
a grade measurement device including a device controller and a sensor, the sensor configured to scan the lawn to create a lawn image, the device controller configured to process the lawn image into grade profile data;
a communication portion for providing communication between the CP and the grade measurement device;
the database that includes the non-transitory computer medium, and the database including the instructions, and
the database storing a grid map that includes a plurality of grid areas that segregate the location; and
the CP configured to:
receive the grade profile data,
map the grade profile data to each of the plurality of grid areas,
compare the grade profile data of each of the plurality of grid areas to an anchor point grade profile,
calculate a grade score for each of the plurality of grid areas based on the respective grade profile data relative to the anchor point grade profile,
for each of the plurality of grid areas, determine whether to add or remove material to the grid area when the grade score for the grid area exceeds a predetermined grade threshold,
select one or more tools from a plurality of tools, and
output a ground slope plan that indicates where to add or remove the material on the location, wherein
the ground slope plan includes reference to the one or more tools selected from the plurality of tools.

2. The system of claim 1, wherein the CP is further configured to:
determine an amount of the material to add or remove; and wherein
the ground slope plan includes the amount of the material to add or remove.

3. The system of claim 1, wherein the CP is further configured to:
determine a type of the material to add or remove based on at least one of a geographical position of the location, a weather forecast, and an almanac data.

4. The system of claim 1, wherein the plurality of tools includes powered equipment configured to move the material.

5. The system of claim 1, wherein the anchor point is a plurality of anchor points including an anchor point of each corner of the grid, a location maximum anchor point, and a location minimum anchor point.

6. The system of claim 1, wherein the CP is further configured to:
indicate where to add or remove material within each grid of the plurality of grid areas.

7. The system of claim 1, further comprising:
a lawnmower, wherein the grade measurement device is removably mounted to the lawnmower and in communication with a plurality of sensors of the lawnmower;
a user device in wireless communication with each of the grade measurement device and the CP; and
the CP further configured to,
determine an amount of the material to add or remove,
indicate where to add or remove the material within each of the plurality of grid areas, wherein
the ground slope plan includes the amount of the material and where to add or remove the material within each of the plurality of grid areas.

8. A lawncare apparatus, to assess a lawn slope to control water runoff and chemical concentrations at a location, the apparatus including a tangibly embodied computer processor (CP) and a tangibly embodied database, the CP implementing instructions on a non-transitory computer medium disposed in the database, and the database in communication with the CP, the apparatus comprising:
a grade measurement device including at least two wheels rotatably connected to a frame, a device controller adjacent the frame, and a sensor adjacent the frame, the sensor configured to scan the lawn to create a lawn image, the device controller configured to process the lawn image into grade profile data;
a communication portion for providing communication between the CP and the grade measurement device;
the database that includes the non-transitory computer medium, and the database including the instructions, and
the database storing a grid map that includes a plurality of grid areas that segregate the location; and
the CP configured to:
receive the grade profile data,
map the grade profile data to each of the plurality of grid areas,
determine a local maximum, a local minimum, and a plurality of corner anchor points for each of the plurality of grid areas based on the grade profile data,
receive a location maximum anchor point and a location minimum anchor point,
compare the local maximum, the local minimum, and the plurality of corner anchor points for each of the plurality of grid areas to the location maximum anchor point and the location minimum anchor point,
calculate a grade score for each of the plurality of grid areas based on the local maximum, the local minimum, and the plurality of corner anchor points relative to the location maximum anchor point and the location minimum anchor point,
for each of the plurality of grid areas, determine whether to add or remove material to the grid area when the grade score for the grid area exceeds a predetermined grade threshold,
select one or more tools from a plurality of tools, and
output a ground slope plan that indicates where to add or remove the material on the location, wherein
the ground slope plan includes information related to the one or more tools selected from the plurality of tools.

9. The apparatus of claim 8, wherein the sensor is removably mounted to the frame.

10. The apparatus of claim 8, wherein the system includes a sensor array that includes the sensor, the sensor is a camera, and the sensor array includes a lidar sensor.

11. The apparatus of claim 10, wherein the sensor array includes at least one tilt sensor.

12. The apparatus of claim 8, wherein the grade measurement device is an autonomous device.

13. The apparatus of claim 8, wherein the grade measurement device is configured to operate based on remote control.

14. The apparatus of claim 8, wherein the grade measurement device includes a material storage and is configured to distribute the material from the material storage.

15. The apparatus of claim 8, wherein the database includes a recommendations database having a plurality of tool data, material data, and equipment data; and
the ground slope plan includes a selection of tools, material, and equipment from the recommendations database.

16. The apparatus of claim 8, wherein the CP is further configured to:
compare the local maximum, the local minimum, and the plurality of corner anchor points for each of the plurality of grid areas to the location maximum anchor point, the location minimum anchor point, and the plurality of corner anchor points of each adjacent grid area; and
calculate a grade score for each of the plurality of grid areas based on the local maximum, the local minimum, and the plurality of corner anchor points relative to the location maximum anchor point, the location minimum anchor point, and the plurality of corner anchor points of each adjacent grid area.

17. A method to assess a lawn slope to control water runoff and chemical concentrations at a location, the method performed by a system including a tangibly embodied computer processor (CP) and a tangibly embodied database, the CP implementing instructions on a non-transitory computer medium disposed in the database, and the database in communication with the CP, the method comprising:
storing the instructions in the database;
storing a grid map in the database, the grid map including a plurality of grid areas that segregate the location;
scanning the lawn to create a lawn image;
creating a grade profile data based on the lawn image;
mapping the grade profile data to each of the plurality of grid areas;
determining a local maximum, a local minimum, and a plurality of corner anchor points for each of the plurality of grid areas based on the grade profile data,
receiving a location maximum anchor point and a location minimum anchor point,
comparing the local maximum, the local minimum, and the plurality of corner anchor points to the location maximum anchor point and the location minimum anchor point for each of the plurality of grid areas,
calculating a grade score for each of the plurality of grid areas based on the local maximum, the local minimum, and the plurality of corner anchor points relative to the location maximum anchor point and the location minimum anchor point,
for each of the plurality of grid areas, determining whether to add or remove material to the grid area when the grade score for the grid area exceeds a predetermined grade threshold,
outputting a ground slope plan that indicates where to add or remove the material on the location.

18. The method of claim 17, further comprising:
determining an amount of the material to add or remove.

19. The method of claim 17, further comprising:
selecting one or more tools from a plurality of tools, wherein
the ground slope plan includes reference to the one or more tools selected from the plurality of tools.

20. The method of claim 19, further comprising:
presenting purchasing options for the one or more tools.
